(19) United States
(12) Patent Application Publication
(10) Pub. No.: US 2024/0161024 A1
(43) Pub. Date: May 16, 2024

(54) Dynamic Tracking and Coordination of Multi-leg Transportation

(71) Applicant: Joby Aero, Inc., Santa Cruz, CA (US)

(72) Inventors: Kellen Christopher Mollahan, Summit, NJ (US); Karl Weston Schulz, Long Island City, NY (US); Matthew David Schwegler, San Francisco, CA (US)

(21) Appl. No.: 18/506,783

(22) Filed: Nov. 10, 2023

Related U.S. Application Data
(60) Provisional application No. 63/424,292, filed on Nov. 10, 2022.

(51) Int. Cl. G06Q 10/0631

(52) U.S. Cl. CPC G06Q 10/06311

(57) ABSTRACT

Example aspects of the present disclosure relate to dynamic tracking and coordination of multi-leg transportation. The example method includes receiving a request for a transportation service. The method includes computing a multi-modal transportation itinerary for the user based on the request. The method includes accessing data associated with the multi-modal transportation service and data associated with a state of the user relative to the multi-modal transportation itinerary. The method includes computing a quality measurement of the multi-modal transportation service based on the data associated with the multi-modal transportation service and the data associated with the state of the user. And, the method includes initiating an adjustment action associated with the multi-modal transportation itinerary for the user based on the quality measurement.

### RELATED APPLICATIONS

The present application claims the benefit of and priority to U.S. Provisional Patent Application No. 63/424,292, filed Nov. 10, 2022, which is hereby incorporated by reference in its entirety.

### FIELD

The present disclosure relates generally to electric aircraft and operations for transporting users via electric aircraft.

### BACKGROUND

Transportation service applications allow individual users to request transportation. For example, service providers can match drivers/vehicles to requests for transporting a rider to a requested destination or delivering packages, goods, or prepared foods. Computing platforms can be used to help facilitate these services.

### SUMMARY

Aspects and advantages of implementations of the present disclosure will be set forth in part in the following description, or may be learned from the description, or may be learned through practice of the implementations.

One example aspect of the present disclosure is directed to a computer-implemented method. The computer-implemented method includes accessing data indicative of a request for a transportation service, wherein the request is indicative of a user for the transportation service. The method includes computing a multi-modal transportation itinerary for the user based on the request. The multi-modal transportation itinerary includes a plurality of transportation legs for providing the multi-modal transportation service. The method includes determining a state of the user relative to the multi-modal transportation itinerary. The state is indicative of a progress of the multi-modal transportation service for the user and the state is associated with a transportation leg of the multi-modal transportation itinerary. The method includes computing a quality measurement of the multi-modal transportation service based on the state of the user. The method includes determining an adjustment action associated with the multi-modal transportation itinerary for the user based on the quality measurement. The adjustment action includes an adjustment associated with another transportation leg of the multi-modal transportation itinerary, the other transportation leg being subsequent to the transportation leg. The method includes transmitting, over a network, an instruction to initiate the adjustment action associated with the multi-modal transportation itinerary for the user.

In some example implementations, the other transportation leg includes a ground transportation service for the user, and wherein the adjustment action includes at least one of: (i) initiating an adjustment to the ground transportation for the user; or (ii) initiating an increase in a priority associated with the user for the ground transportation.

In some example implementations, adjusting the ground transportation for the user includes at least one of: (i) assigning a different ground vehicle to the user; (ii) changing a service level associated with the ground transportation for the user; or (iii) changing a service type associated with the ground transportation.

In some example implementations, increasing the priority associated with the user for the ground transportation includes adjusting a data structure for assigning a ground vehicle to the user to increase the priority with which the ground vehicle is assigned to the user.

In some example implementations, the other transportation leg includes an aerial transportation service for the user, and wherein the adjustment action includes at least one of: (i) initiating an adjustment of a seat for the user on an aircraft to be used for the aerial transportation service; or (ii) initiating an assignment of the user to a different aircraft for the aerial transportation service.

In some example implementations, computing the quality measurement of the multi-modal transportation service based on the state of the user includes: accessing data associated with the multi-modal transportation service, wherein the data associated with the multi-modal transportation services includes at least one of timing data, movement data, data associated with another user, or event data received from at least one of a plurality of distributed computing devices associated with the multi-modal transportation service; and computing the quality measurement of the multi-modal transportation service based on the state of the user and the data associated with the multi-modal transportation service.

In some example implementations, computing the quality measurement of the multi-modal transportation service based on the state of the user and the data associated with the multi-modal transportation service includes: accessing a time threshold associated with the user state of the user, wherein the time threshold is based on historical transportation data for the user state; computing a state waiting time for the user based on the data associated with the multi-modal transportation service, the state waiting time descriptive of a period of time that the user remains in the user state; and computing the quality measurement based on a comparison of the time threshold and the state waiting time.

In some example implementations, wherein the user is associated with one or more user characteristics, and wherein the time threshold associated with the user state is based the one or more user characteristics.

In some example implementations, the time threshold associated with the user state is based on a geographic region associated with the multi-modal transportation service.

In some example implementations, determining the adjustment action associated with the multi-modal transportation itinerary for the user based on the quality measurement includes: computing a predicted overall service score for the multi-modal transportation service based on the quality measurement, wherein the predicted overall service score is indicative of a predicted quality of the multi-modal transportation service across a plurality of states of the multi-modal transportation service; and determining the adjustment action based on the predicted overall service score, wherein the adjustment action is configured to impact a final overall service score.

In some example implementations, computing the predicted overall service score for the multi-modal transportation service includes: determining a weighted quality measurement based on the user state; and computing the predicted overall service score based on the weighted quality measurement.

In some example implementations, computing the predicted overall service score for the multi-modal transportation service includes: accessing one or more other quality measurements of the multi-modal transportation service for one or more other states of the user relative to the multi-modal transportation itinerary; and computing the predicted overall service score based on an aggregation of the quality measurement and the one or more other quality measurements of the multi-modal transportation service.

In some example implementations, the state is one of a plurality of predefined user states, the plurality of predefined user states including a transit state, a transitional state, a boarding state, a ready state, and an arrival state.

Another example aspect of the present disclosure is directed to one or more non-transitory, computer-readable media storing instructions that are executable by one or more processors to cause the one or more processors to perform operations. The operations include accessing data indicative of a multi-modal transportation itinerary for a user. The multi-modal transportation itinerary includes a plurality of transportation legs for providing a transportation service for the user. The operations include determining a state of the user relative to the multi-modal transportation itinerary. The state is indicative of a progress of the multi-modal transportation service for the user and the state is associated with a transportation leg of the multi-modal transportation itinerary. The operations include computing a quality measurement of the multi-modal transportation service based on the state of the user. The operations include determining an adjustment action associated with the multi-modal transportation itinerary for the user based on the quality measurement. The adjustment action includes an adjustment associated with another transportation leg of the multi-modal transportation itinerary, the other transportation leg being subsequent to the transportation leg. The operations include transmitting, over a network, an instruction to initiate the adjustment action associated with the multi-modal transportation itinerary for the user.

In some example implementations, the user is associated with a user device configured to run a software application associated with the transportation service, and wherein the adjustment action includes a modification to at least one user interface of the software application.

In some example implementations, the at least one user interface of the software application is configured to provide one or more user notifications, and wherein initiating the adjustment action includes: accessing alternative transportation data associated with an alternative transportation service; computing a user notification descriptive of a comparison between the alternative transportation service and the multi-modal transportation service; and transmitting, over the network, data indicative of the user notification to the user device during the multi-modal transportation service.

In some example implementations, the adjustment action includes notifying an operator at an aerial facility to assist the user in transitioning between a ground transportation service to an aerial transportation service, and wherein transmitting the instruction to initiate the adjustment action includes transmitting, to a user device associated with the operator, data indicative of a notification to assist the user while at the aerial facility.

In some example implementations, the user state is one of a plurality of predefined user states, wherein each respective state is associated with a corresponding weight for determining a weight quality measurement associated with the respective state.

In some example implementations, the operations further include receiving feedback data associated with the transportation service; and modifying the corresponding weight of at least one respective state based on the feedback data.

Yet another example aspect of the present disclosure is directed to a computing system that includes one or more processors and one or more tangible, non-transitory, computer readable media that store instructions that are executable by the one or more processors to cause the computing system to perform operations. The operations include accessing data indicative of a request for a transportation service, wherein the request is indicative of a user of the transportation service. The operations include computing a multi-modal transportation itinerary for the user based on the request. The multi-modal transportation itinerary includes at least two transportation legs for providing the multi-modal transportation service. The operations include accessing data associated with the multi-modal transportation service and data associated with a state of the user relative to the multi-modal transportation itinerary. The data associated with the multi-modal transportation service is indicative of a location of the user relative to the multi-modal transportation itinerary. The operations include computing a quality measurement of the multi-modal transportation service based on the data associated with the multi-modal transportation service and the data associated with the state of the user. The operations include initiating an adjustment action associated with the multi-modal transportation itinerary for the user based on the quality measurement.

Other example aspects of the present disclosure are directed to other systems, methods, vehicles, apparatuses, tangible non-transitory computer-readable media, and devices for improving the operation of, and computational efficiency associated with, aircraft.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example multi-modal transportation service according to example implementations of the present disclosure;

FIG. 2 depicts a map diagram of an example multi-modal transportation itinerary and aerial routes according to example implementations of the present disclosure;

FIG. 3 depicts a graphical representation of an example aerial facility according to example implementations of the present disclosure;

FIG. 4 depicts an example computing ecosystem for providing a transportation service according to example implementations of the present disclosure;

FIG. 5 depicts an example computing device register according to example implementations of the present disclosure;

FIG. 6 depicts an example service instance register according to example implementations of the present disclosure;

FIG. 7 depicts example computing systems for providing an example multi-modal transportation service according to example implementations of the present disclosure;

FIG. 8A depicts a state diagram for initiating an adjustment action according to example embodiments of the present disclosure;

FIG. 8B depicts an example dynamic data model according to example embodiments of the present disclosure;

FIG. 9 depicts a flowchart diagram of an example method for initiating an adjustment action according to example embodiments of the present disclosure;

FIG. 10 depicts a flowchart diagram of an example method for computing a real-time quality measurement according to example embodiments of the present disclosure;

FIG. 11 depicts a flowchart diagram of an example method for computing a predicted overall service score and an associated action according to example embodiments of the present disclosure; and

FIG. 12 depicts a block diagram of an example computing system according to example implementations of the present disclosure.

### DETAILED DESCRIPTION

Generally, the present disclosure is directed to techniques for improving the computational efficiency of a transportation service and a user's experience associated therewith. A user can request a transportation service to travel to a destination location. In response, a computing system (e.g., a centralized, cloud-based platform system) can generate a multi-modal transportation itinerary for the user. The multi-modal transportation itinerary can include a plurality of transportation legs associated with different transportation modalities. As an example, the itinerary can include the user traveling via a ground vehicle for an initial leg of the trip, an aircraft for an intermediate leg, and another ground vehicle for the last leg.

A user can transition between a plurality of states during the performance of each of the legs, which can be monitored by the computing system. As further described herein, the states can be indicative of the various phases experienced by the user during the transportation service such as, for example: a first leg transit state, an intermediate leg arrival state, a boarding state, a take-off ready state, an intermediate leg transit state, a last leg arrival state, a last leg transit state, etc.

As the user progresses along the transportation service (e.g., through the various states), the computing system can automatically compute real-time quality measurements for the respective states of the user. In this example context, the quality measurement can be considered “real-time” since it is being calculated as the user progresses along the transportation service. The real-time quality measurements can include an objective score descriptive of the quality of at least a portion of the transportation service. For example, the real-time quality measurement for a transit state of a first ground vehicle transportation leg can indicate whether the user is having a favorable experience as the user is transported in a ground vehicle for the first transportation leg.

In the event that the real-time quality measurement indicates that the user's experience is not currently favorable, the computing system can determine an adjustment action. The adjustment action can include a change to a subsequent transportation leg that would improve the user's experience (and overall service score) associated with the transportation service. This can include, for example, prioritizing the user when matching with a ground vehicle on the last transportation leg to decrease user wait time and improve the efficiency of the user's transportation service. In this manner, real-time information associated with a transportation service can be leveraged to improve the provision of a computationally complex, multi-modal transportation service.

The technology of the present disclosure can provide a number of improvements to transportation computing technology. For instance, the technology of the present disclosure leverages a specific computing ecosystem and a plurality of discrete user states to improve the computing efficiency, accuracy, and personalization for the real-time monitoring and adjustment of transportation services. For instance, a transportation service can be divided into a plurality of discrete user states that specify a user's location or activity at a particular point of the transportation service. A distributed computing ecosystem of devices located relative to the plurality of discrete user states is leveraged to make real-time quality measurements (e.g., as a user progresses through the transportation service). The real-time quality measurements are correlated with a discrete user state to adjust a transportation service, in real-time, as the user is traveling. In this regard, the distributed computing ecosystem of devices, in combination with the plurality of discrete user states, can be utilized to identify and initiate an adjustment action for a transportation itinerary that is directly tailored to counteract an inefficiency of a service that includes multiple, different modes of transportation for the user.

By correlating the real-time quality measurements with the discrete user states, actions for improving the transportation service can be tailored to a specific location or activity associated with a negative quality measurement. In this manner, the present disclosure presents an improved computing system that can accumulate and distribute newly available information such as, for example, real-time quality measurements tied to discrete user states to provide a practical application that improves the utilization of computing systems for the facilitation of transportation services.

### Example Multi-Modal Transportation Service

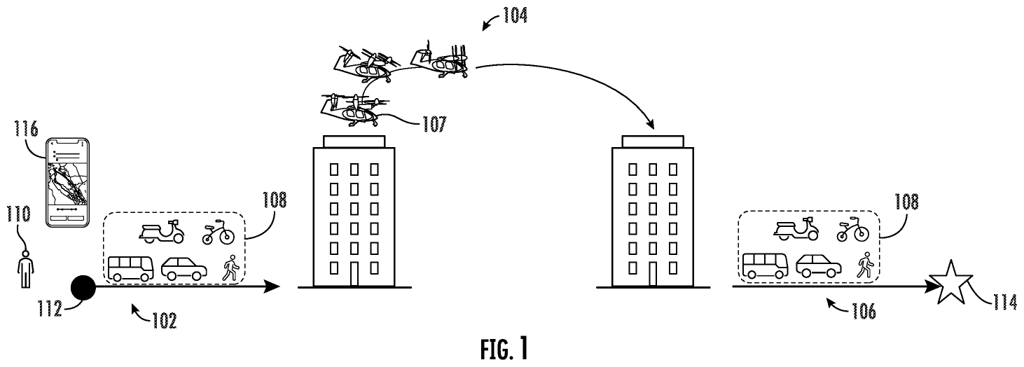

FIG. 1 depicts an example process flow of a multi-modal transportation service according to example implementations of the present disclosure. A multi-modal transportation service can include multiple transportation legs 102, 104, 106 associated with at least two different transportation modalities. For example, the multi-modal transportation service can include a first transportation leg 102, one or more second transportation legs 104, and a third transportation leg 106.

A combination of ground vehicles, aircraft, or other types of vehicles can perform the various legs of the multi-modal transportation service. Each transportation leg of the multi-modal transportation service can be associated with a respective transportation modality. For instance, the first transportation leg 102 can be associated with a first transportation modality using one or more of ground vehicles 108 such as an automobile. A second transportation leg 104 can be associated with a second transportation modality using an air-based modality such as an aircraft 107. The third transportation leg 106 can be associated with a third transportation modality, which can be the same or different from the first or second modalities. For example, the third transportation leg 106 can use a ground modality such as another automobile, bicycle, walking route, etc.

The aerial transport can include one or more different aircraft such as airplanes, vertical take-off and landing vehicles (“VTOLs”), or other aircraft including conventional take-off and landing vehicles (“CTOLs”). VTOLs, for example, can include one or more different types of rotorcraft (e.g., helicopters, quadcopters, gyrocopters, etc.), tilt-rotor aircraft, powered-lift vehicles, and/or any other vehicle capable of vertically taking-off and/or landing (e.g., without a runway).

As shown in FIG. 1, the aircraft used in the multi-modal transportation service can include a VTOL that is configured to operate in multiple flight modes. For example, an aircraft can include multirotor configurations such that the position, orientation, etc. of the aircraft's rotors can be adjusted to allow the aircraft to operate in the various flight modes. This can include, for example, a first rotor position that allows the aircraft to take-off, land, or hover vertically and a second rotor position that allows the aircraft to travel forward (e.g., “cruise”) using a thrust force.

The aircraft can include one or more types of power sources such as batteries, a combustible fuel source, electrochemical sources (such as a hydrogen fuel cell system), or a combination thereof. For example, the aircraft can include electric VTOLs (“eVTOLs”) capable of operating using one or more electric batteries, VTOLs capable of operating using combustible fuel, or VTOLs using hybrid propulsion systems.

The multi-modal transportation service can be provided in an on-demand manner. The service can include a ridesharing, ride-hailing, vehicle reservation, or delivery service. The multi-modal transportation service can be coordinated for a user 110 by one or more service providers.

A service provider can be an entity that offers, coordinates, manages, etc. a transportation service. This can include a transportation network company, vehicle fleet manager, etc. For example, a user 110 may desire to travel on a journey from an origin location 112 to a destination location 114. The user 110 can interact with a user device 116, via a user interface of a software application, to book transportation for the journey. The user 110 can interact with user device 116 over one or more user sessions.

Based on the user sessions, at least one service entity can compile one or more options for the user 110 to traverse the journey. The user device 116 of the user 110 may present these options to the user 110 via a user interface of the software application. At least one option for the journey can include the multi-modal transportation service. Responsive to selection of the multi-modal transportation service option by the user 110, the service can be initiated for transportation for user 110.

To track and coordinate the multi-modal transportation service, a user itinerary can be computed for the user 110. A user itinerary (also referred to as a “multi-modal itinerary”) can be defined by a data structure that includes various information associated with a user's trip from an origin location to a destination location. As used herein, user itinerary may refer to the user itinerary or the underlying data structure depending on the context. The user's itinerary may include: identifiers for locations of interest (e.g., names/coordinates for origins, destinations, vertiports, etc.), times/durations the user is at each location, transportation modalities, specific vehicle assignments, seat assignments, real-time location data, luggage information, or other information. The user itinerary can be updated in real-time as the user 110 progresses along the journey, in response to any changes to the journey, etc. The user itinerary can be available to the user 110 via the user device 116.

Building user itineraries on-demand across modalities can involve centralized or distributed scheduling of resources associated with each modality. For instance, example implementations can involve systems and devices that interface with user 110, systems and devices associated with a first modality of transportation, and systems and devices associated with a second modality of transportation.

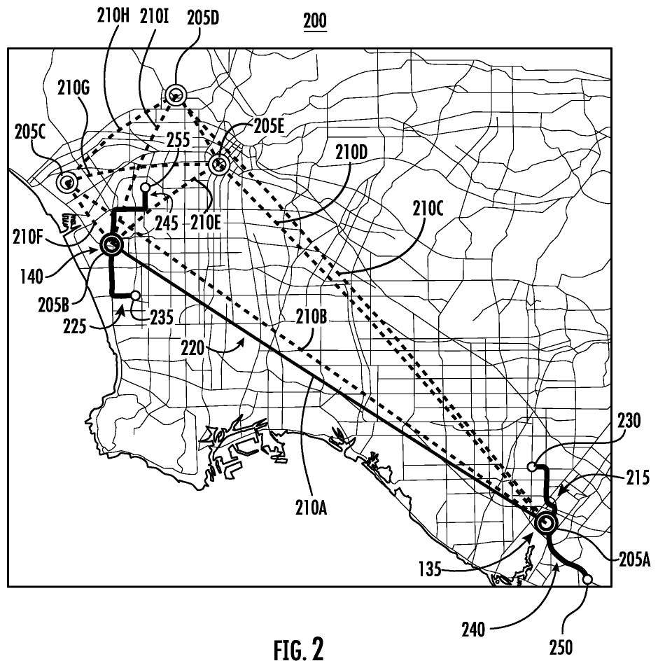

The itinerary of the user 110 can be based on the user's origin location, destination location, available intermediate locations for transitioning between transportation modalities, vehicle routes, and/or other information. For example, FIG. 2 depicts a graphical map diagram of an example multi-modal transportation service within a geographic area 200 according to example implementations of the present disclosure. The geographic area 200 can be, for example, an urban environment.

The geographic area 200 can include a network of intermediate locations that can be used for transitioning a user from one transportation modality to another. For instance, the geographic area 200 can include a plurality of aerial facilities 205A-E. The aerial facilities 205A-E (e.g., vertiports) can allow a user to transition from a ground transportation modality to an aerial transportation modality, or vice versa. The plurality of aerial facilities 205A-E can be placed at various locations within the geographic area 200. The plurality of aerial facilities 205A-E can be connected by a plurality aerial routes 210A-J. In some implementations, the aerial routes 210A-J can be designed with respect to airspace constraints (e.g., noise constraints, air traffic constraints, etc.). In some implementations, demand modeling can be performed to select high value infrastructure locations for placing the plurality of aerial facilities 205A-E throughout the geographic area 200 and generating routes 210A-J between the aerial facilities 205A-E, without interfering with the airspace constraints. This network of aerial facilities 205A-E and routes 210A-J can be utilized to create flight plans for aircraft used within the multi-modal transportation service 100 to indicate how and where a particular aircraft may travel through an operational time period.

Multiple users can be pooled together for multi-modal transportation services, such that different user itineraries can share at least one transportation leg. This can include pooling users to share an intermediate transportation leg (e.g., a flight on an aircraft), even though the users may have different origin or destination locations.

By way of example, a first user itinerary for a first user can include three transportation legs 215, 220, and 225 (shown in bold in FIG. 2). The first user itinerary can include transporting the first user from a first origin location 230 to a first intermediate location (e.g., aerial facility 205A) to a second intermediate location (e.g., aerial facility 205B) and, ultimately, to a first destination location 235. The first and second intermediate locations can be determined based on their proximity (e.g., being the closest aerial facilities) to the first origin location 230 and the first destination location 235, respectively. The first user itinerary can include ground transportation modalities (e.g., cars, etc.) along the first and last transportation legs 215, 225 and an aerial transportation modality (e.g., VTOLs) along the intermediate transportation leg 220.

A second user itinerary for a second user can include three transportation legs 240, 220, and 245 (shown in bold in FIG. 2). The second user itinerary can include transporting the second user from a second origin location 250 to the first intermediate location (e.g., aerial facility 205A) to the second intermediate location (e.g., aerial facility 205B) and, ultimately, to a second destination location 255. The second user itinerary can include ground transportation modalities along the first and last transportation legs 240, 245 and an aerial transportation modality along the intermediate transportation leg 220.

The first user and the second user can be pooled together for the intermediate transportation leg 220. For example, the first user itinerary and the second user itinerary can respectively indicate that the first user and the second user are to travel in the same flight of an aircraft traveling along route 210A, to transport the users between aerial facility 205A and aerial facility 205B. In this manner, the first and second users can share at least one transportation leg for cost and power efficient multi-modal transportation.

### Example Aerial Facility

The intermediate locations within a multi-modal transportation service can be configured to help seamlessly transition users from one transportation leg or modality to another. As described herein, these intermediate locations can include aerial facilities for facilitating the take-off (e.g., departure) and landing (e.g., arrival) of aircraft utilized in a multi-modal transportation service.

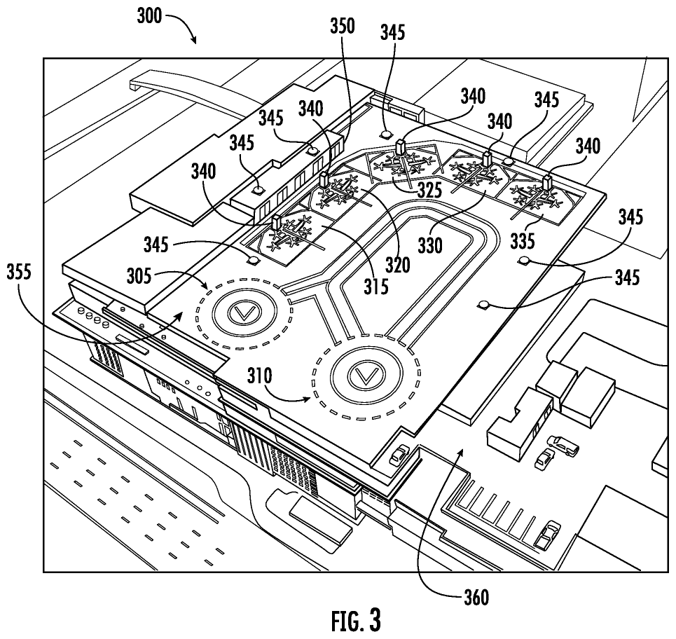

By way of example, FIG. 3 depicts a graphical diagram of an example aerial facility 300 according to example implementations of the present disclosure. The aerial facility 300 can include a vertiport with one or more final approach and landing pads 305, 310 (e.g., FATO pads), one or more vehicle parking locations 315-335, or other infrastructure for maintaining and facilitating the functions of aircraft (e.g., VTOLs). For example, the aerial facility 300 can include infrastructure 340 which can include hardware and software for refueling or recharging an aircraft between flights. Various portions of the infrastructure 340 can be accessible at one or more of the vehicle parking locations 315-335.

The aerial facility 300 can include a structure or area for transitioning a user to and from an aerial transportation leg of a multi-modal transportation service. The aerial facility 300 can be located in a geographic area where multi-modal transportation services are offered. For instance, the aerial facilities can include a building or designated area within a geographic area. In some implementations, the aerial facility 300 can be a portion (e.g., a roof, dedicated floors, etc.) of a building or structure that may be used for other purposes (e.g., commercial, residential, industrial, parking, etc.).

The aerial facility 300 can include one or more sensors 345. The sensors can include visual, audio, or other types of sensors. For example, the sensors can include cameras, microphones, vibration sensors, motion sensors, RADAR sensors, LIDAR sensors, infrared sensors, temperature sensors, humidity sensors, other weather condition sensors, etc. The sensors 345 can be configured to access sensor data (e.g., noise data, weather data, aircraft-related data, etc.) within and around the aerial facility 300.

The aerial facility 300 can include one or more output devices. The output devices can include display screens, speakers, lighting elements, or other infrastructure to communicate information to users, facility operators, vehicle operators, or other individuals at the aerial facility 300. For example, display screens can be utilized to indicate an aircraft assigned to a user and a parking location assigned to an aircraft. The aerial facility 300 can include paths for users to travel to or from aircraft. In some implementations, the output devices (e.g., lighting elements) can help indicate the paths to the users.

The aerial facility 300 can include charging infrastructure configured for charging or otherwise service the energy storage system of an aircraft. For example, the aerial facility 300 can include chargers that are configured to physically connect with the aircraft at a charge port. The chargers can provide charge to the batteries of the aircraft, to increase the charge level of the aircraft. The aerial facility 300 can include various types of chargers to accommodate various types of aircraft, types/configurations of charge points, types/configurations of batteries, etc.

The charging infrastructure can also include systems for battery conditioning. This can include, for example, systems for thermal management of the batteries of an aircraft. The thermal management systems may cool the temperature of the aircraft batteries. The battery temperature may be cooled to a target temperature for the aircraft to perform a subsequent flight. The target temperature may be based on the specification of the batteries, the parameters of the subsequent flight, the downtime of the aircraft, etc.

In some implementations, the charging infrastructure may include one or more other systems for monitoring battery health and status. This can include systems that are configured to run diagnostics on the aircraft batteries to detect any anomalies, damage, etc.

The aerial facility 300 can include one or more access points 350 for user ingress and egress. The access points 350 can include designated areas, elevators, stairwells, etc. The access points 350 can also help users to transition between transportation legs and the different modalities associated therewith. For example, after being dropped-off at the aerial facility 300 by a ground vehicle for a first transportation leg, a user can utilize an access point 350 to enter an area 355 for checking-into a flight for the next transportation leg, an area for boarding an aircraft, etc. After unloading from the aircraft at the aerial facility 300, a user can utilize an access point 350 to access an area 360 for boarding a ground vehicle for a last transportation leg.

An aerial facility 300 can be operated by various entities. For example, a service entity that manages a fleet of aircraft or coordinates a transportation service can own, control, operate, etc. the aerial facility 300. In some implementations, the aerial facility 300 can be owned, controlled, operated, etc. by a third-party facility provider. The third-party facility provider may not have its own aircraft fleet but may operate the aerial facility 300 or permit other entities to utilize the aerial facility 300.

The aerial facility 300 can be utilized by a single entity or shared among a plurality of entities. For example, a service entity that manages/operates a fleet of aircraft can own, lease, control, operate, etc. the entire aerial facility 300. The service entity and its associated fleet may exclusively utilize the aerial facility 300, such that aircraft outside the service entity's fleet are not permitted at the aerial facility 300, except in emergency circumstances. In another example, a first service entity that manages/operates a first fleet of aircraft can share the aerial facility 300 with a second service entity that manages/operates a second fleet of aircraft.

In some implementations, certain resources at the aerial facility 300 can be assigned to a particular fleet or service entity. For example, a first set of landing pads, parking pads, infrastructure, storage areas, waiting areas, chargers, etc. can be designated for the first service entity and its associated fleet. A second set of landing pads, parking pads, infrastructure, storage areas, waiting areas, etc. can be designated for the second service entity and its associated fleet. In some implementations, the resources at the aerial facility 300 can be shared such that the shared resources can be assigned dynamically, throughout an operational time period based on user/aircraft itineraries, charging needs, etc.

The aerial facility 300 can include an aerial facility computing system, not shown in FIG. 3. The aerial facility computing system can be configured to monitor and control the various resources of the aerial facility 300. This can include, for example, monitoring and controlling infrastructure such as chargers, sensors, output devices, etc. The aerial facility computing system can include one or more computing devices and can communicate with other computing systems and devices associated with the multi-modal transportation service.

### Example Computing Ecosystem for Multi-Modal Transportation Service

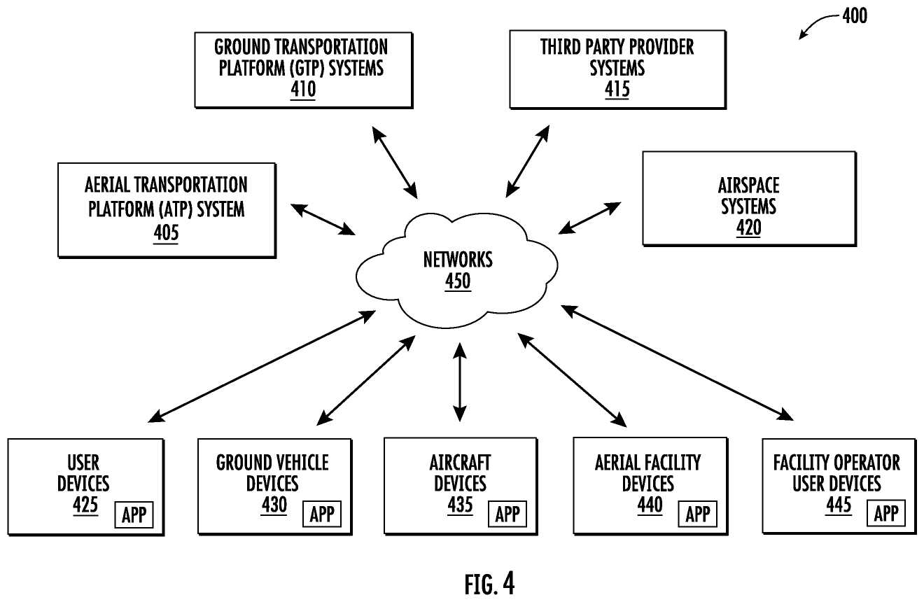

FIG. 4 depicts a block diagram illustrating an example networked ecosystem 400 for cross-platform coordination for multi-modal transportation services. Multiple network-connected systems can cooperatively interact within ecosystem 400 to provide multi-modal transportation services. As shown, ecosystem 400 may include a distributed computing system with a plurality of different participating systems/devices communicatively connected over one or more networks 450.

The ecosystem 400 can include one or more transportation platform systems such as, for example, an aerial transportation platform (ATP) system 405 and one or more ground transportation platform (GTP) systems 410. The ecosystem 400 can include third-party provider systems 415, airspace systems 420, user devices 425, ground vehicle devices 430, aircraft devices 435, aerial facility devices 440, or facility operator user devices 445.

Each of the systems or devices can communicate over one or more wireless or wired networks 450. Networks 450 can include one or more types of networks including telecommunications networks, internet, private networks, or other networks, as further described herein.

The systems and devices of ecosystem 400 can include a plurality of software applications operating on the respective systems and devices. This can create an ecosystem of applications for providing and coordinating a multi-modal transportation services, as further described herein.

User devices 425 can include computing devices owned or otherwise accessible to a user of a transportation service. For example, a user device 425 can include a hand-held computing device (e.g., a phone, a tablet, etc.), a wearable computing device (e.g., smart watch, smart glasses, etc.), personal desktop devices, or other devices. User devices 425 can execute one or more instructions to run an instance of a software application for a respective transportation platform and present user interfaces associated therewith. User devices 425 can include personal devices (e.g., a mobile device) or shared devices on which a user has initiated a personal session (e.g., by logging into a public kiosk or display device in a vehicle, etc.).

A GTP system 410 can be associated with a service entity that provides a ground transportation service. GTP systems 410 can include a computing platform (e.g., a cloud services platform, server system, etc.) communicatively connected over networks 450 to one or more of the systems or devices of networked ecosystem 400.

GTP systems 410 can include or implement one or more client-facing software applications accessible to the devices of ecosystem 400. Users can interact with the GTP systems 410 (e.g., using user devices 425, ground vehicle devices 430, aircraft devices 435) to receive various types of transportation services (e.g., delivery, ridesharing, or ride-hailing, etc.) including the multi-modal transportation services described herein. For example, a GTP system 410 can match one of its associated ground vehicles or operators with users for a ground transportation service.

GTP systems 410 can be associated with ground infrastructure for facilitating the performance of a ground transportation service. The ground infrastructure can include one or more parking areas, vehicle transfer hubs, charging/fueling locations, storage facilities, etc.

GTP systems 410 can be associated with a fleet of ground vehicles and the vehicle operators can include a network of ground vehicle operators. As described herein, ground vehicles can include automobiles, bikes, scooters, autonomous vehicles, etc. The network of ground vehicle operators can include drivers or remote operators that facilitate, oversee, or control the movement of ground vehicles available to perform ground transportation services.

Ground vehicle devices 430 can include computing devices or systems associated with a ground vehicle or operator. For example, ground vehicle devices 430 can include one or more vehicle computing systems such as, for example, an onboard computer for operating the vehicle, an autonomy system, an infotainment system, etc. Additionally, or alternatively, ground vehicle devices 430 can include an operator's user device. For example, a ground vehicle device can be a driver's mobile phone. In some implementations, ground vehicle devices 430 can include a user device that remains onboard a ground vehicle such as, for example, a tablet that is available to an operator or passenger.

An ATP system 405 can be associated with one or more service entities that provide at least an aerial transportation service to users. ATP system 405 can include a computing platform (e.g., a cloud services platform, server system, etc.) communicatively connected over networks 450 to one or more of the systems or devices of networked ecosystem 400.

ATP systems 405 can include or implement one or more client-facing software applications accessible to the devices of ecosystem 400. Users can interact with ATP system 405 (e.g., using user devices 425, ground vehicle devices 430, aircraft devices 435) to receive various types of information related to a transportation service. For example, a user (e.g., a rider) can interact with ATP system 405 via an instance of a software application (e.g., a rider app) running on user device 425 to request and book a multi-modal transportation service. A facility operator can interact with ATP system 405 via an instance of a software application (e.g., an operations app) running on an aerial facility device 440 or a facility operator user device 445 to view/adjust flight information, seat assignments, etc.

In some implementations, the software application of one system can be run within or accessed by the software application of another system. For example, a user interface of a software application associated with an ATP system 405 can be embedded within and displayed with the user interface of the software application associated with the GTP system 410, or vice versa. This can allow a user to utilize one application, while accessing another for a particular transportation leg (e.g., aerial transport).

ATP systems 405 can be associated with one or more aircraft, aircraft operators, aerial facilities (or portions thereof), facility operators, etc. for facilitating the performance of at least an aerial transportation service. For example, the aircraft can include a fleet of aircraft and the vehicle operators can include a network of aircraft operators. The network of aircraft operators can include pilots or remote operators that facilitate, oversee, or control the movement of aircraft available to perform aerial transportation services.

Aerial facilities used for providing a transportation service can include one or more aerial facility devices 440. Aerial facility devices 440 can be positioned at various locations within or around the aerial facility to collect and receive information associated with an aerial transportation service. Aerial facility devices 440 can include one or more charging devices associated with charging infrastructure of the aerial facility, one or more vehicle positioning devices (e.g., motorized tugs, etc.), one or more sensors or surveillance devices (e.g., noise sensors, cameras, etc.), etc.

Facility operators can be associated with an aerial facility to assist users with security checks, check-ins, boarding/de-boarding, performing aircraft checks, etc. The facility operator user devices 445 can include user devices utilized by the facility operators. Facility operator user devices 445 can be used to communicate with a transportation platform or perform various functions at an aerial facility. For example, facility operator user devices 445 can run one or more software applications to complete security checks, check in/out luggage, coordinate re-charging/refueling, present safety briefings, or the like.

Aircraft devices 435 can include one or more aircraft computing systems or aircraft operator user devices. For instance, aircraft devices 435 can include a computing system onboard an aircraft such as a pilot interface, an avionics system, an infotainment system, a navigation system, an autonomy system, or any other sensors or devices located on an aircraft and capable of sending or receiving information. Aircraft devices 435 can include an aircraft operator's user device (e.g., a pilot's mobile phone). Aircraft devices 435 can include a user device that remains onboard the aircraft such as, for example, a tablet or display that is available to a passenger or operator.

The ecosystem 400 can include one or more airspace systems 420. Airspace systems 420 can include one or more airspace data exchanges or otherwise be associated with regulatory bodies configured to collect real-time, historical, or regulatory airspace data. The airspace systems 420 can include, for example: (i) aggregating systems that pool airspace data associated with an airspace; (ii) third-party monitoring systems configured to monitor aspects of an airspace (e.g., noise, etc.); or (iii) regulatory systems that can confirm, validate, or approve an aerial transportation service before take-off based on one or more policies or standards set by a regulatory body (e.g., Federal Aviation Administration, European Aviation Safety Agency, etc.).

The ecosystem 400 can include one or more third-party provider systems 415. Third-party provider systems 415 can be associated with one or more third parties that provide resources to ATP systems 405 or GTP systems 410. For example, third-party provider systems 415 can be associated with a third-party aircraft provider, including one or more “third-party” aircraft. Third party aircraft can include aircraft provided, leased, loaned, or otherwise made available by an entity for use by ATP systems 405 for transportation services, as further described herein.

Additionally, or alternatively, third-party provider systems 415 can be associated with a provider of one or more third-party aircraft operators. Third-party aircraft operators can include, for example, a plurality of aircraft pilots that may be available to ATP systems 405 for operation of an aircraft for the transportation services.

In some implementations, third-party provider systems 415 can be associated with a third-party facility provider that can provide facilities (or facility resources) for use in performing transportation services. For example, the third-party facility provider can own, operate, etc. one or more aerial facilities (or portions thereof) that can be rented, leased, or otherwise utilized by a transportation platform system for providing an aerial transportation service. ATP systems 405 or GTP systems 410 can communicate directly or indirectly (e.g., through third-party provider systems 415) with the third-party aircraft, operators, or infrastructure.

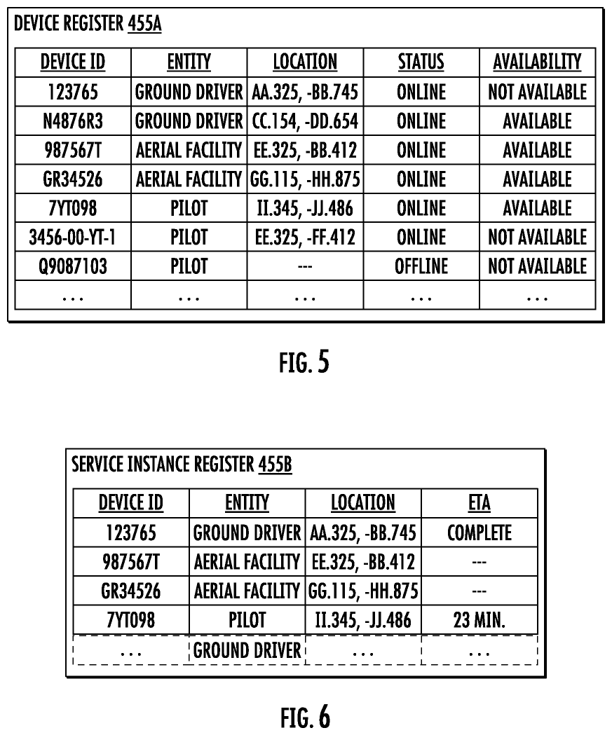

The systems and devices of ecosystem 400 may be registered for potential use when providing and coordinating a multi-modal transportation services. FIG. 5 illustrates an example device register 455A. Device register 455A can include a table or other data structure indicating devices/systems participating in the on-demand transportation platform ecosystem, such as ecosystem 400. Device register 455A can include fields such as Device ID, Entity, Location, Status, Availability, etc.

The device register 455A can be maintained in a local or remote database. Systems and devices can register for participation in ecosystem 400 by providing information to a registration service. Such information can include system/device identifiers, associated entities, IP addresses, downloading an application, signing-up or creating an account, or other information for identifying and communicating with the system/device. The device register 455A can be updated to provide a real-time reference for the characteristics and status of participating systems/devices. This can include, for example, determining whether a device is online or offline (e.g., powered on and connected, or not) or whether the device is available (e.g., not currently being utilized for another task) or unavailable (e.g., being utilized for another task).

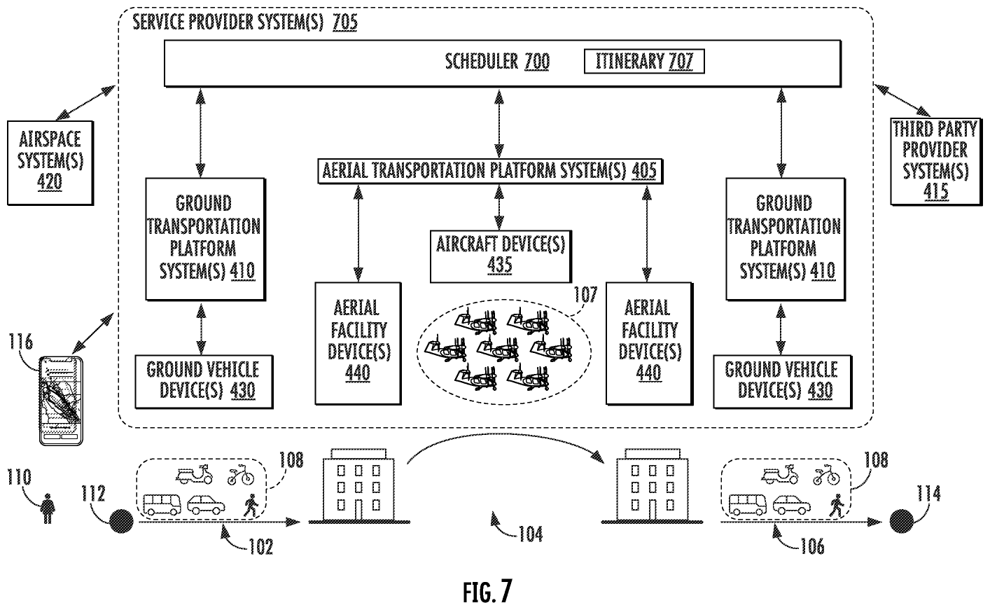

When building a user itinerary, a service instance register can be created, such as an example service instance register 455B shown in FIG. 6. A service instance register 455B can include a data structure with one or more data objects that indicate the devices to be utilized for facilitating and progressing a user along their journey.

An ATP system 405 (or another system) can build a service instance register 455B for servicing a particular service request. Service instance register 455B can be associated with a unique or distinct service instance identifier for a particular user itinerary for providing at least one leg of a transportation service. Service instance register 455B can assemble a selection of participating devices from device register 455A. Service instance register 455B can include a minimum set of participating devices to complete at least a leg of a journey. Service instance register 455B may include all participating devices to complete the entire leg of a journey.

The ATP system 405 (or another system) can update and reconfigure service instance register 455B as needed to accommodate for scheduling changes, delays, device substitution, etc. or as the journey/itinerary progresses for a particular user. For example, as the user progresses along a second leg of a particular journey, the ATP system 405 (in communication with a GTP system 410) may identify and select a ground vehicle for servicing the last leg of the user's journey. In response, the ground vehicle device associated with the selected ground vehicle can be listed in the service instance register 455B. In this manner, service instance registers 455B can accurately reflect the systems/devices of the ecosystem 400 that are associated with each particular service instance for the users of the multi-model transportation service.

### Example Data Flow for Computing Ecosystem for Multi-Modal Transportation Service

To help improve the performance of ecosystem 400 for efficiently allocating resources across multiple different systems and modalities, example implementations of the present disclosure provide a vehicle request coordination system that contains scheduler 700. Scheduler 700 can coordinate requests from multiple client systems for space on one or more vehicles (e.g., aircraft operated by an ATP, etc.) for building an on-demand multi-modal transportation itinerary 707 (also referred to as multi-modal itinerary 707 or itinerary 707).

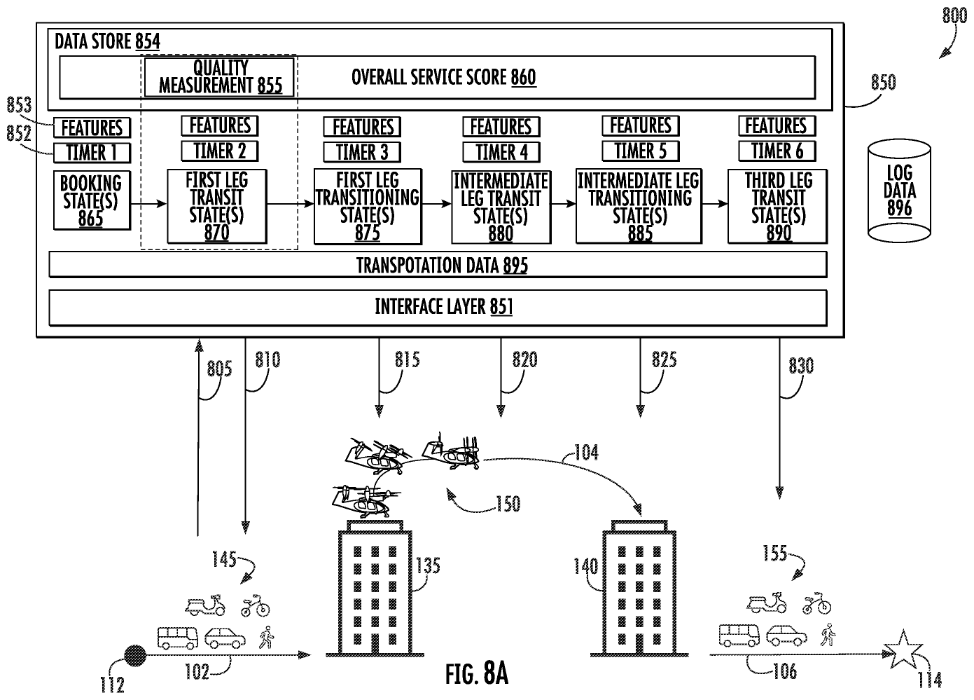

FIG. 7 is a block diagram illustrating systems and devices that can respectively correspond to the various modalities of an example multi-modal transportation service. FIG. 7 illustrates how the various computing devices of computing ecosystem 400 may be implemented and interact with one another within the context of the end-to-end multi-modal journey described with reference to FIG. 1, as well as example data flows associated therewith.

User 110 can interact with software operating on user device 116 to communicate with one or more service provider systems 705 to request a transportation service. The service provider systems 705 can include, for example, ATP systems 405 or GTP systems 410. The service provider systems 705 can also include devices associated with the vehicles and facilities used in a multi-modal transportation service. Service provider systems 705 can include scheduler 700 that builds on-demand multi-modal itineraries. The service providers can communicate with airspace systems 420 or third-party provide systems 415 to help coordinate the transportation services.

### Example ATP Client-Facing System Implementation

Still with reference to FIG. 7, in some implementations, an ATP system 405 can be a client-facing system that receives a user request and builds an itinerary 707 for a user 110. In such an implementation, scheduler 700 may be a component of (or accessible to) the ATP system 405 to help compute the itinerary 707.

For instance, a user device 116 can communicate with an ATP system 405 to request a transportation service for a journey. The user device 116 can execute an application associated with the ATP system 405. This can be an application associated with a service entity that controls the ATP system 405. The ATP system 405 can access availability data for its aircraft to identify, or create, a flight for transporting the user 110 along an aerial leg of the journey (e.g., second leg 104). Based on the flight, the ATP system 405 (using scheduler 700) can request, from one or more GTP systems 410, availability of ground vehicles for transporting the user 110 along a leg preceding the aerial leg (e.g., first leg 102) and along a leg succeeding the aerial leg (e.g., third leg 106). Additionally, or alternatively, user walking instructions may be provided for these legs. The ATP system 405 can, with scheduler 700, compile a multi-modal itinerary 707 for providing the transportation service.

The ATP system 405 can communicate the compiled itinerary to the user device 116. The user device 116 can receive the proposed multi-modal itinerary 707 from ATP system 405 and present it for selection by the user 110. For instance, the user 110 can view the proposed multi-modal itinerary 707 in a user interface of the application associated with the ATP system 405.

In the event the user selects the multi-modal itinerary 707, the ATP system 405 can communicate with certain devices to coordinate the user's journey. For example, the ATP system 405, with scheduler 700, can communicate with GTP systems 410. The GTP systems 410 can communicate with one or more ground vehicle devices 430 to assign a vehicle for the user 110 for the first transportation leg 102 and a vehicle for the third transportation leg 106. The assignment of the vehicle for the third transportation leg 106 may occur before, or while, the user 110 is travelling along the journey (e.g., during the second leg 104). The ATP system 405 can communicate with aerial facility devices 440 to provide them with information regarding the user's journey. This can help facilitate the user's transition between the different legs at the respective aerial facilities. The ATP system 405 can communicate with aerial vehicle devices 435 to provide seat assignments or other flight information for the aircraft 107 that is assigned to transport the user 110.

In some implementations, the service entity associated with the ATP system 405 may have a fleet of ground vehicles for providing ground transportation to the user 110. As such, the GTP systems 405 may be internal client systems for communicating with these ground vehicle fleets.

### Example GTP Client-Facing System Implementations

Still with reference to FIG. 4, in some implementations, a GTP system 420 can be a client-facing system that receives a user request and builds a multi-modal itinerary 707 for a user 110. In such an implementation, scheduler 700 may be a component of (or accessible to) the GTP system 410 to help compute the itinerary 707.

For instance, a user device 116 can communicate with a GTP system 410 to request a transportation service for a journey. The user device 116 can execute an application associated with the GTP system 410. This can be an application associated with a service entity that controls the GTP system 410 such as, for example, a ground vehicle ridesharing/hailing app.

The GTP system 410, with scheduler 700, can request a vehicle slot on an aircraft of one or more ATP systems 405. A vehicle slot can include a seat for the user 110 and/or cargo space for the user's luggage or delivery item. The ATP systems 405 can access availability data for its aircraft to identify, or create, one or more candidate flights for transporting the user 110 along an aerial leg of the journey (e.g., second leg 104).

In some implementations, the ATP system 405 can provide the information associated with the candidate flights to the GTP system 410. This can include take-off/landing times, boarding times, departing/arrival facilities, aircraft identifiers, or other information. Based on the candidate flights, the GTP system 410 may identify its available ground vehicles for transporting the user 110 along the first transportation leg 102 and third transportation leg 106. Additionally, or alternatively, user walking instructions may be provided for these legs. The GTP system 410 can, with scheduler 700, compile a multi-modal itinerary 707 for providing the transportation service.

The GTP system 410 can communicate the compiled itinerary to the user device 116. The user device 116 can receive the proposed multi-modal itinerary 707 from the GTP system 410 and present it for selection by the user 110. For instance, the user 110 can view the proposed multi-modal itinerary 707 in a user interface of the application associated with the GTP system 410.

In the event the user selects the multi-modal itinerary, the GTP system 410 can communicate with certain devices to coordinate the user's journey. For example, the GTP system 410, with scheduler 700, can communicate with ATP systems 405. The ATP systems 405 can communicate with aerial facility devices 440 to provide them with information regarding the user's journey, as described herein. The ATP system 405 can communicate with aerial vehicle devices 435 to provide seat assignments or other flight information for the aircraft 107 that is assigned to transport the user 110.

The GTP system 410 can communicate with one or more ground vehicle devices 430 to assign a vehicle for the user 110 for the first transportation leg 102 and a vehicle for the third transportation leg 106. The assignment of the vehicle for the third transportation leg 106 may occur before, or while, the user 110 is travelling along the journey (e.g., during the second leg 104).

In some implementations, the GTP system 410 may be the user-facing system that receives the user's transportation request, but ATP systems 405 may include scheduler 700 and be configured to build an itinerary for the GTP system 410. For instance, the GTP system 410 may request, from one or more ATP systems 405, a flight or a multi-modal itinerary for the user 110. The ATP systems 405 may compute a multi-modal itinerary based on availability data for its aircraft and data indicating ground vehicle availability, which may be accessed via the GTP system 410. The ATP systems 405 may communicate the itinerary to GTP system 410 for provision to the user 110.

### Example Real-Time Computation of Quality Measurements for Dynamic User Transportation States Using a Distributed Computing Ecosystem

The technology of the present disclosure can improve the operations of the multi-modal transportation service by dynamically measuring a user's experience as the user progresses along the transportation service. This can allow a transportation platform to make adjustment actions to improve the efficiency of the transportation service and improve the user experience therewith.

One or more embodiments described herein provide that methods, techniques, and actions performed by a computing system/device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

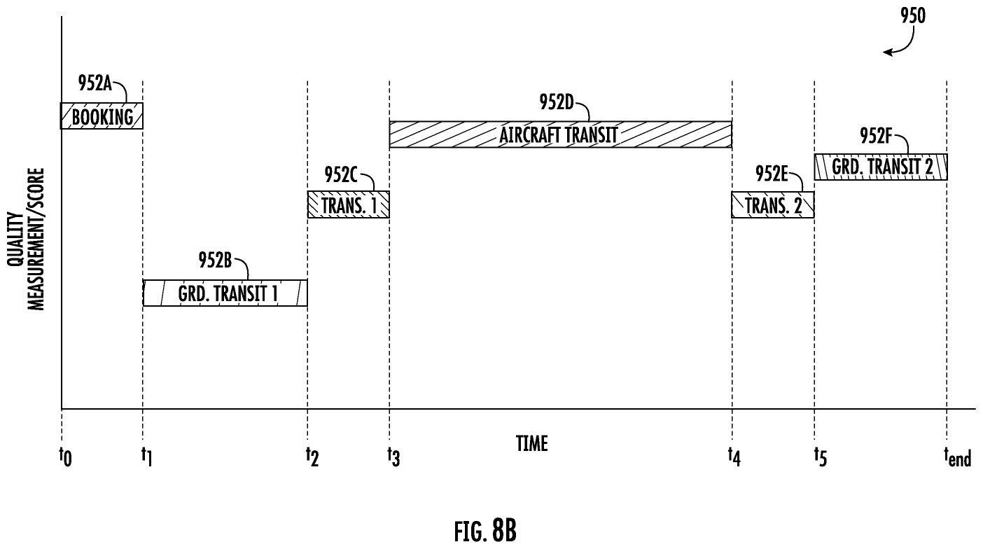

FIG. 8A and its accompanying description provide an overview of the example programmatic operations implemented by a computing system according to the present disclosure. Thereafter, FIG. 8B and its accompanying description illustrate an example data model that can be dynamically generated by the computing system in real-time during performance of the operations according to the present disclosure.

FIG. 8A depicts a state diagram 800 for initiating an adjustment action according to example embodiments of the present disclosure. The state diagram 800 depicts a computing system 850 (e.g., a transportation platform system) that is configured to monitor a transportation service and automatically compute (e.g., in real-time) quality measurements 855 for a user as the user progresses through the multi-modal transportation service. The computing system 850 can predict an overall service score 860 based on the quality measurements 855 and initiate an action to improve the overall service score 860.

The computing system 850 can initiate the action by communicating with one or more of the systems and devices of the computing ecosystem 400. The action can modify the first transportation leg 102, the intermediate transportation leg 104, or the last transportation leg 106 of a multi-modal transportation service. For instance, the action can modify a first transportation modality 145 of the first leg 106, a second transportation modality 150 of the intermediate leg 104, third transportation modality 155 of the last leg 106, or a first intermediate location 135 or a second intermediate location 140. The transportation modalities can include the ground vehicles 108 and/or aircraft 107 depicted in FIGS. 1 and 7.

The computing system 850 can be a component of a service provider system 705. For example, the computing system 850 can be implemented as a back-end service of an ATP system 405 that is coordinating a transportation service.

As further described below, the computing system 850 (or a host system thereof) can be configured to access and process various data from various sources. In some implementations, the computing system 850 may communicate directly with a computing system/device to obtain the data. By way of example, a service provider system 705 may be a single orchestrator of a transportation service. The computing system 850 may be implemented within a service provider system 705 that can directly communicate with a user device of a user, a ground vehicle device, an aerial facility device, an aircraft device, etc. As such, the applications running on these devices may be configured to cause the underlying device to automatically transmit data to the computing system 850 via the interface layer 851 according to an API that defines a structure for the data to be ingested by the computing system 850. In some implementations, the computing system 850 can transmit a request for such data to a device, which can compute a data payload and communicate the data payload to the computing system 850 in response.

In some implementations, the computing system 850 (host system thereof) may access data from various sources through an intermediate computing system. By way of example, a service provider system 705 may be included among multiple orchestrators that work together to provide of a transportation service. This can include an ATP system 405 or GTP system 410 that communicates with other platforms to coordinate a multi-modal transportation service. Service level agreements between the platforms can define the data that one platform is to provide another, the frequency of transmission, format, etc. By way of example, a GTP system 410 can provide the computing system 850 with IMU or location data from the user device of the user or a ground vehicle 108 while the user is on a first leg 102 and/or the last leg 106. An ATP system 405 can provide the computing system 850 with IMU or location data from the user device of the user or an aircraft 107 while the user is on an intermediate leg 104.

In some implementations, the computing system 850 (or a host system thereof) can be configured to query another platform for certain data. For example, the computing system 850 may access an API of a GTP system 405 to structure a query for certain user feedback data associated with the first leg 102 of a transportation service. In response to the query, the GTP system 405 can return the requested feedback data indicating, for example, the user's rating of the driver for the first leg transportation.

In this way, the computing system 850 can access data for tracking and computing a user's experience along different states/portions of a requested transportation service. The following provides an example dataflow for such computation.

More particularly, the computing system 850 can receive a request for a transportation service. The request can be transmitted from a user device and structured according to an API of the computing system 850.

For example, the request can be a query structured in a manner compatible with the interface layer 851 of the computing system 850. The interface layer 851 can include or perform processes that run on the network-side of the computing system 850 to establish communication channels with individual devices. For example, the interface layer 851 can establish secure sockets with different types of mobile devices, which service providers/operators can utilize when providing transportation services to a user.

The request can encode various information. For example, the request can be indicative of one or more users, an origin location 112, or a destination location 114. In some implementations, the request can include a user identifier. The user identifier can be utilized by the computing system 850 to access a profile from a database that stores characteristics associated with the user identifier.

In some implementations, the user can be associated with one or more user characteristics such as a user score, accessibility, service history, preferences, etc. As one example, the user characteristics can be indicative of one or more past requests or completed transportation services for the user. In some implementations, the user characteristics can be informative of a user's familiarity with a transportation service. This can include, for example, a frequency or number of past multi-modal transportation services that have been taken/requested by the user.

The computing system 850 can generate a multi-modal transportation itinerary for the user based on the request. The multi-modal transportation itinerary can include itinerary data for the multi-modal transportation service. The itinerary data can be indicative of a plurality of transportation legs for providing the multi-modal transportation service. As an example, the multi-modal transportation itinerary can include a first transportation leg 102 that is provided by a first ground vehicle, an intermediate transportation leg 104 that is provided by an aircraft, and a last transportation leg 106 that is performed by a second ground vehicle.

The itinerary data can indicate the modality for each transportation leg, a transition point (e.g., a pick-up/drop-off location) between each leg, and, in some implementations, one or more expectations for the transportation service. By way of example, the one or more expectations can identify an expected time of arrival at a transition point, an expected vehicle/driver for a transportation leg, or any other predicted information subject to change depending on real-world circumstances.

The computing system 850 can monitor the progress of the user as the user travels according to the multi-modal transportation itinerary. As described herein, this can include communication among one or more platforms. In some implementations, the user's progress can be monitored through a plurality of predefined user states, each associated with a location or activity encountered during the performance of the multi-modal transportation service. As examples, the predefined user states can include an initial booking state 865 and: (i) one or more transit states, (ii) one or more transitional states, (iii) one or more boarding states, (iv) one or more ready states, or (v) one or more arrival states.

As one example, the booking state 865 can be initiated when a software application is launched on the user's device creating a user-network session with the computing system 850. The booking state 865 can define the time period during which the user attempts to book a transportation service. The booking state 865 can terminate, for example, when a vehicle is assigned to transport the user on the first transportation leg 102.

As another example, the predefined user states can include (i) a first leg transit state 870 during which a user is transported from the origin location 112 to the first intermediate location 135 (e.g., a first aerial facility), (ii) a first leg transitioning state 875 during which a user boards an aircraft at the first intermediate location, (iii) an intermediate leg transit state 880 during which a user is transported from the first intermediate location 135 to the second intermediate location 140 (e.g., a second aerial facility), (iv) an intermediate leg transitioning state 885 during which a user deboards an aircraft at the second intermediate location 140, and (v) a third leg transit state 890 during which a user is transported from the second intermediate location 140 to the destination location 114.

Each of the state(s) 870, 875, 880, 885, 890 can include one or more substates. As one example, a first leg transitioning state can include an arrival substate, a check-in substate, a boarding substate, a boarded substate, a take-off substate, etc.

The triggering conditions for each state (or substate) can be stored in an adaptable data structure (e.g., table) in an accessible memory. These conditions can be referenced by the logic of the computing system 850 and can be changed or refined over time. The computing system 850 can be programmed to track and automatically update the state of the user based on the conditions defined in the adaptable data structure.

For example, the computing system 850 can transition the state of the user based on transportation data 895. The transportation data 895 can include real-time information received from at least one of the distributed computing devices associated with the multi-modal transportation service (e.g., systems/devices of the computing ecosystem 400). The distributed computing devices, for example, can include one or more user devices such as, for example, a mobile phone, a desktop computer, one or more smart devices (e.g., smartwatch, smart glasses, etc.), etc. In addition, the distributed computing devices can include vehicle devices such as an onboard vehicle computing system (e.g., autonomy computing system, onboard aircraft computing system, etc.) or a device of a vehicle operator (e.g., driver, pilot, etc.) helping to perform the multi-modal transportation service. In some implementations, the distributed computing devices can include one or more facility devices or personnel devices associated with the transition points of the multi-modal transportation service.

The transportation data 895 can include positional information for the user (or an associated vehicle) relative to the multi-modal transportation itinerary. The positional information can include sensor data such as global positioning system (“GPS”) data, inertial measurement unit (“IMU”) data, auditory data, image data, etc. recorded by one or more sensors of the plurality of distributed computing devices. As one example, the sensor data can include GPS-based data recorded by a user device or a vehicle device.

In addition, or alternatively, the computing system 850 can transition the state of the user based on user input provided to a computing device. The user input can include an indication of the location of the user at various positions along the multi-modal transportation itinerary. For example, personnel at a transition point for the multi-modal transportation (e.g., an aerial facility) can provide user input to an associated user device to indicate that the user (e.g., the rider) has arrived at the transition point, has boarded an aircraft, etc. This can include, for example, adjusting a toggle or other UI element on a user interface to cause the user device to transmit a signal encoding an indication that the user has arrived, boarded, etc. The computing system 850 can access this signal and dynamically update the user state of the user during the performance of the multi-modal transportation service based on the real-time information.

In some implementations, the transportation data 895 can include at least one of timing data, movement data, or event data. The timing data can be indicative of a period of time during which the user is positioned at various positions along the multi-modal transportation itinerary. The movement data can be indicative of a user's physical movement and can be used to detect travel conditions. The movement data, for example, can include measurements of a user's movement during one or more time intervals, whereas a user's position can refer to the position of the user with respect to the multi-modal transportation itinerary. The event data can be indicative of an exceptional travel condition such as, for example, proximity to a sick passenger, etc.

The computing system 850 can determine a state of the user relative to the multi-modal transportation itinerary. A state can be indicative of a progress of the multi-modal transportation service for the user.

Updating the state of the user can include adjustment of a data structure that reflects the current and/or past states of a user. For example, updating the state of the user can include adding one or more data entries to one or more fields in a row of a table. The data entries can be indicative of the user's location, start time, end time, etc. The row can be associated with a particular state. New entries can be made to the table as the user progresses along the itinerary 707. Moreover, the computing system 850 can label entries/rows as associated with past, completed states once the user has transitioned to the next state or the transportation service has completed. The data structures can be associated with a particular service instance and stored with, or linked to, the user's profile.

The computing system 850 can associate real-time information with a user state indicative of the position of the user relative to the multi-modal transportation itinerary. For example, the computing system 850 can identify a current user state and associate data with the current user state. In some implementations, the associated data can include timing data indicative of a time period in which a user remains at each of the predefined user states.

The timing data can be recorded by a state timer 852 configured to record an amount of time spent at each user state. The state timer 852 can be a virtual timer configured to record a split time between each transition of the plurality of predefined states as the user progresses through a multi-modal transportation service. In some implementations, the computing system 850 can operate the timer 852 (e.g., split timer) based on the real-time information (e.g., positional information, user input, etc.) received from the plurality of distributed computing devices. In addition, or alternatively, a split time can be recorded or received from one or more of the plurality of distributed computing devices.

In some implementations, as shown in FIG. 8A, each state can be associated with a particular state timer that is programed to start and stop based on the triggering conditions defined for each state.

As will be further described with reference to FIG. 8B, the state times can be utilized to build a unique timeline graph model in real-time to compute the respective quality measurement 855 of a state and the overall service score 860.

In some implementations, the computing system 850 can access input features 853 associated with a particular state. For example, the software application running on a user device can allow the user to provide feedback about their experience during a particular state. This can include inputting text or selecting UI elements that describe the user's experience. The software application can process this information and package it as a data set for transmission to the computing system 850 as interface input signals. The interface input signals can encode, for example, the user's feedback.

The computing system 850 can process the interface input signals and store the feedback as input features 853 associated with a particular state. In the event that the interface input signals are provided to an intermediate computing system (e.g., of a GTP system), they can be provided to the computing system 850 by the intermediate computing system through the interface layer 851 using an API.

The computing system 850 can compute a quality measurement 855 of the multi-modal transportation service based on the state of the user. The quality measurement 855 can include a calculated score (e.g., expressed as a numerical value, percentage, range, letter, color, etc.) descriptive of the quality of at least a portion of the multi-modal transportation service. For example, each portion of the multi-modal transportation service, for example, can be represented by a respective user state of the plurality of predefined user states. The computing system 850 can compute a respective quality measurement 855 for each respective pre-defined state of user.

In addition, or alternatively, the quality measurement 855 can correspond to a sub-score corresponding to an associated transportation leg.

The computing system 850 can compute an overall service score 860 that quantifies the objective quality of the multi-modal transportation service from start to finish. The overall service score 860 can include an aggregation of a plurality of sub-scores (e.g., quality measurements 855) corresponding to different portions of the multi-modal transportation service. Aggregation can correspond to a sum, weighted or unweighted average, a mean value, a maximum value, minimum value, or any other appropriate measure. As will be further described with reference to FIG. 8B, the computing system 850 can build, in real-time, a dynamic data model that represents/tracks the quality measurements in real-time and the change in overall service score for a service instance.

In some implementations, the quality measurement 855 for the associated user state can be computed based on the data associated with the multi-modal transportation service and one or more thresholds. The thresholds can be stored in a look-up table or other data structure that is accessible to the computing system 850. Example thresholds can include: (i) timing thresholds indicative of a threshold period of time during which the user should transition in and out of a respective user state; (ii) movement thresholds indicative of a tolerance for an amount of movement during a respective user state; or (iii) event thresholds indicative of a tolerance for one or more unexpected events during a respective user state.

Each threshold can be tailored to a respective user state based on the location or activity involved with each user state. By way of example, a movement threshold can be set based on the type of movement acceptable for the mode of transportation. This can include, for example, the amount of stop-and-go acceleration jerk acceptable to a passenger in a car (e.g., as measured by IMU data). As another example, a timing threshold for a boarding state may be higher than a timing threshold for an initial booking state to account for precautionary procedures when boarding an aircraft.

The thresholds can be determined based on historical data. The historical data can be indicative of a plurality of historical transportation services or feedback data associated therewith. For example, the historical data can be indicative of the historical timing, movement, or events corresponding to individual user states along each of the plurality of historical transportation services. The thresholds for each user state can be determined based on the historical timing, movement, or events corresponding to the respective state.

As an example, the timing threshold for a respective state can include an average, or a percentage of, the period of time for historically transitioning a user in and out of the first leg transit state 870.

In some implementations, the thresholds can be tailored to a particular user or geographic region. For instance, the thresholds for each user state can be determined based on the historical timing, movement, or events corresponding to a respective state of a plurality of historical transportation services performed for the particular user or within a particular geographic region. As examples, the thresholds associated with a user state can be based on: (i) one or more user characteristics to account for a user's familiarity with the multi-model transportation service (e.g., given a number of previous services undertaken); or (ii) a geographic region to account for delays (e.g., air traffic delays, etc.), turbulence, etc. prevalent in the geographic region. In this manner, the thresholds can be better tailored to the expectations of a specific multi-modal transportation service.

The computing system 850 can determine a quality measurement 855 for a respective user state such as, for example, the first leg transit state 870. The computing system 850 can do so based on a comparison between the thresholds for the respective state and the data associated with the multi-modal transportation service. As one example, the computing system 850 can access a time threshold associated with a user state of the user (e.g., via a stored look-up table). The computing system 850 can compute a state waiting time for the user descriptive of a period of time that the user remains in the respective user state. The state waiting time can be computed using a timer 852 that measures the duration of a particular state given conditions for starting and terminating a state. For example, the timer 852 for the first leg transit state can initiate when a ground vehicle is assigned to the user and terminate when the user is dropped off at the first intermediate location 135 (e.g., first aerial facility). As described herein, the initiation/termination of a timer 852 can be based on the monitored position of the user, signals from devices, etc. Such information can be communicated to the computing system 850 from the individual computing devices or from another platform via the interface layer 851.

The computing system 850 can compute the quality measurement 855 based on a comparison of the time threshold and the state waiting time. The quality measurement 855, for example, can be higher in the event that the state waiting time does not exceed the time threshold and lower in the event that the state waiting time does exceed the time threshold. For example, a user could be in a first leg transit state 870 (e.g., riding in a ground vehicle) on the way to a first intermediate location 135 for a time that is over the time threshold for that transit state. As a result, the quality measurement 855 can be lower to reflect the unfavorable wait time. In some implementations, the quality measurement 855 can change (e.g., decrease) exponentially as the state waiting time continues to exceed the time threshold.

Additionally, or alternatively, the quality measurement 855 can be based on the input features 853. For example, the quality measurement 855 for a first leg transit state can be higher in the event that the input features are indicative of a positive user experience during the first transportation leg 102. This can include, for example, a high rating of a driver. The quality measurement 855 for a first leg transit state can be lower in the event that the input features are indicative of a negative user experience during the first transportation leg 102 (e.g., a lower driver rating).

In some implementations, the quality measurement 855 for a particular user can be based on one or more other users associated with the particular user. For instance, a first user can be onboard or waiting to board an aircraft for an intermediate transportation leg 104. A second user can be assigned to the same aircraft as the first user such that the first and second users are pooled together for the intermediate transportation leg 104.

The second user can be associated with a different state than the first user. For example, the first user can be associated with a first leg transition state 875 as the first user is waiting to board the aircraft or waiting for the aircraft to take-off. The second user can be associated with a first leg transit state 870 as the second user is travelling to the first intermediate location 135 (e.g., a first aerial facility).

The computing system 850 can determine a predicted quality measurement of the first user based on data associated with the second user. For instance, as described herein, the computing system 850 can receive the data associated with the multi-modal transportation service. The data associated with the multi-modal transportation service can include location or state data associated with the second user (e.g., determined using GPS-based data from a mobile device). The location or state data can indicate the progress of the second user along the first transportation leg 102.

The computing system 850 can determine a predicted quality measurement of the first user based on the location or state data associated with the second user. For instance, the computing system 850 can determine that the second user is or will be delayed in arriving to the intermediate location 135. The computing system 850 can also determine that take-off for the aircraft (e.g., assigned to the first and second user) will be delayed as a result of the delay of the second user. The computing system 850 can determine that the first user will remain in the first leg transitioning state 875 for an additional time period. The computing system 850 can aggregate (e.g., sum) the amount of time that the first user has already been in this state and the additional time period (e.g., while waiting the second user) to predict the total time the first user will be in the first leg transitioning state 875. The computing system 850 can compare the predicted total time to a threshold for the first leg transitioning state 875 to predict if the first user will be in the first leg transitioning state 875 for an amount of time greater than the threshold.

Based on this comparison, the computing system 875 can determine a predicted quality measurement for the first user. For instance, in the event that the predicted total time is greater than the time threshold, the computing system 875 can predict that the quality measurement 855 for the first user (e.g., at least for the first leg transitioning state 875) will be lower due to the delay of the second user. In the event that the predicted total time is less than the time threshold, the computing system 875 can predict that the quality measurement 855 for the first user (e.g., at least for the first leg transitioning state 875) will be minimally impacted due to the delay of the second user. The computing system 855 can continue to monitor the impact of the second user's delay on the first user's quality measurement 855 to determine if the quality measurement 855 would be reduced.

The computing system 850 can initiate an adjustment action for the transportation itinerary based on the real-time quality measurement 855 and the user state. The adjustment action can be configured to counteract a negative quality measurement or emphasize a positive quality measurement to help improve a final overall service score 860. To implement an adjustment action, the computing system 850 can adjust previously assigned values or parameters stored in a data structure representing the user's itinerary 707. Implementation of the adjustment action can also include the transmission of signals to various distributed computing devices to adjust user assignments, update user interfaces, provide notifications to operators, etc.

An adjustment action can be initiated during a current user state (e.g., corresponding to the real-time quality measurement 855 currently being calculated), during a user state subsequent to the user state, or after the performance of the multi-modal transportation service.

The adjustment action can cause an adjustment to a current transportation leg corresponding to the quality measurement 855 or a future transportation leg subsequent to the current transportation leg. As one example, the user state can be associated with the first transportation leg 102 of the multi-modal transportation itinerary 707 and the adjustment action can be initiated during a second transportation leg of the multi-modal transportation itinerary 707 that is subsequent to the first transportation leg 102. The adjustment action can include an adjustment to a transportation service associated with the second transportation leg. As further explained in the following examples, adjustment actions can occur at one or more stages (e.g., 810-830) of the multi-modal transportation service.

In some implementations, the computing system 850 can initiate an adjustment action for the last transportation leg 106 to increase a quality measurement for the third leg transit state 890 to counteract or complement the quality measurement 855 for the first leg transit state 870.

As one example, the user can be traveling via a ground transportation service from the origin location 112 to the first intermediate location 135 in accordance with a first transportation leg 102. This can be, for example, the initial transportation leg of a multi-modal transportation service. The computing system 850 can collect transportation data 895 for the first transportation leg at (805). This can include, for example, location data captured or generated by a sensor (e.g., GPS, IMU, etc.) of the user's user device. The computing system 850 can compute a quality measurement 855 that indicates that the user is having a less favorable experience (e.g., due to wait times, traffic, high acceleration jerk, etc.) associated with the first leg transit state 870.

In response, at (830), the computing system 850 can determine and initiate an adjustment action for a second, subsequent transportation leg such as, for example, the last transportation leg 106. This can include an adjustment action associated with another ground transportation service that transports the user to the destination location 114.

The adjustment action can include at least one of: (i) adjusting the ground transportation for the user; or (ii) increasing a priority associated with the user for the ground transportation. Adjusting the ground transportation for the user can include at least one of: (i) assigning a different ground vehicle to the user; (ii) changing a service level associated with the ground transportation for the user (e.g., from an economy service to a luxury service); or (iii) changing a service type associated with the ground transportation (e.g., from a pooled-rider service to a single rider service).

The computing system 850 can increase the priority associated with the user for the ground transportation by adjusting a data structure (e.g., a queue, list, etc.) for assigning a ground vehicle to the user to increase the priority with which the ground vehicle is assigned to the user. In addition, or alternatively, the data structure can be adjusted to match the user with a particular vehicle class or vehicle service. In some implementations, the computing system 850 can transmit signals to another computing system (e.g., of a ground transportation provider). The signals can encode a request for increasing the user's priority, vehicle type, etc. according to an API of the other computing system.

Additionally, or alternatively, at (820), the computing system 850 can determine and initiate an adjustment action for a subsequent transportation leg such as the intermediate transportation leg 104 that includes an aerial transportation service. For instance, the computing system 850 can initiate an adjustment action for the intermediate transportation leg 104 to increase a quality measurement for the intermediate leg transit state 880 to counteract or complement the quality measurement 855 for the first leg transit state 870. The adjustment action can include at least one of: (i) adjusting a seat for the user on an aircraft to be used for the aerial transportation service; or (ii) assigning the user to a different aircraft for the aerial transportation service. By way of example, the adjustment action can include assigning a different aircraft for the aerial transportation service to lower an estimated time of arrival at the destination location. As another example, a seat can be adjusted to counteract a late arrival of a user at a first intermediate location 135 by assigning a seat closer to the entrance/exit of the vehicle, assigning a luxury seat instead of an economy seat, etc.

Adjustment actions can also be initiated at intermediate locations to help counterbalance a quality measurement 855 and improve an overall score. For instance, at (815), the computing system 850 can initiate an adjustment action at the first intermediate location 135 to increase a quality measurement for the first leg transitioning state 875 to counteract or complement the quality measurement 855 for the first leg transit state 870. Additionally, or alternatively, at (825), the computing system 850 can initiate an adjustment action at the second intermediate location 140 to increase a quality measurement for the intermediate leg transitioning state 885 to counteract or complement the quality measurement 855 for the first leg transit state 870. In some implementations, the adjustment actions associated with the first intermediate location 135 or second intermediate location 140 can include providing information to the user to transition to the next mode of transportation more efficiently. This can include notifications or map data to help guide the user, as will be further described herein.

The computing system 850 can initiate adjustment actions by communicating with at least one of the plurality of distributed devices associated with the multi-modal transportation service. For instance, the computing system 850 can transmit, over a network, an instruction to initiate the adjustment action associated with the multi-modal transportation itinerary 707 for the user. The instruction can be transmitted to a ground vehicle, aircraft, or personnel devices associated with the adjustment action.

For instance, the computing system 850 can determine an unfavorable real-time quality measurement 855 (e.g., due to an extended waiting time) for a user state associated with the first transportation leg 102. In response to the unfavorable real-time quality measurement 855, the computing system 850 can determine the adjustment action, identify a subsequent user state corresponding to the adjustment action, and transmit the instruction to initiate the adjustment action to at least one of the plurality of distributed devices associated with the subsequent user state.

In some implementations, initiating an adjustment action can include transmitting a message to another platform. For example, the computing system 850 can be included within an ATP system 405. The computing system 850 can transmit a message to a GTP system 410 to initiate an adjustment action with respect to a transportation leg that includes ground vehicle transport. For example, the computing system 850 can submit a request (e.g., structured according to an API) for the user to be prioritized, upgrade a vehicle type, etc.

In another example, the computing system 850 can be included within a GTP system 410. The computing system 850 can transmit a message to an ATP system 405 to initiate an adjustment action with respect to a transportation leg that includes aerial transport. For example, the computing system 850 can submit a request (e.g., structured according to an API) for the user to be assigned a new seat, upgraded, etc.

In some implementations, the adjustment action can include providing a notification to one or more of the plurality of distributed devices associated with the subsequent user state. For instance, the computing system 850 can identify a subsequent user state corresponding to the adjustment action and provide a notification to the user computing device indicative of the adjustment action and the subsequent user state. The notification, for example, can be indicative of the adjustment action for a subsequent transportation leg such as a change in aircraft seat, an upgrade in a subsequent vehicle type, etc.

As another example, the notification can include information for enabling the user to counteract a negative/unfavorable real-time quality measurement 855. For instance, the computing system 850 can determine a negative/unfavorable real-time quality measurement for a user state associated with a first intermediate location 135 (e.g., due to difficulty finding a boarding area at the aerial facility). In response to the negative/unfavorable real-time quality measurement, the computing system 850 can generate a user notification including information for a next transition point (e.g., the second intermediate location 140) of the multi-modal transportation service. The information can include directions to better direct the user at the second transition point, etc.

In one example, the computing system 850 can access a database storing a map of the aerial facility. The computing system 850 can generate a custom map for the user that overlays a path from arrival location of the user (e.g., the car drop-off location or landing pad of the aircraft) to the user's next relevant location (e.g., a waiting/boarding location for the next vehicle). The computing system 850 can transmit signals encoding the custom map to a user device. The signals can cause the user device to render the custom map for the user.

In addition, or alternatively, the adjustment action can include additional assistance at the second transition point and the computing system 850 can provide a notification indicative of the additional assistance to a personnel device associated with the second transition point. For example, the computing system 850 can transmit signals (e.g., to a facility operator device) instructing a facility operator to help provide the user with additional assistance.

The adjustment action can include a modification to at least one user interface of the software application running on a user device. These user interface adjustments and notifications can occur while the user is in the state associated with reduced quality measurement. For instance, at (810), the computing system 850 can initiate an adjustment action for the first transportation leg 105 while the user is in the first leg transit state 870 based on the quality measurement 855 for the first leg transit state 870.

By way of example, a user device of a user can be running a software application associated with the transportation service while the user is in the first leg transit state 870. At least one user interface of the software application can be configured to provide one or more user notifications. The computing system 850 can initiate the adjustment action by causing the user interface to provide one or more user notifications to: (i) identify one or more benefits achieved by the multi-modal transportation service; (ii) provide directions to speed up the transportation service (e.g., to direct a lost user); (iii) provide one or more updates (e.g., upgraded service, etc.) to the multi-modal transportation service, etc.

As one example, the computing system 850 can communicate with the user computing device to provide a comparison between the timing, reliability, or environmental impact of the multi-modal transportation service and alternative transportation services to emphasize a positive real-time quality measurement 855.

To do so, the computing system 850 can determine alternative transportation data associated with at least one alternative transportation service such as, for example, a single leg, ground transportation service. The alternative transportation data can be indicative of an estimated time of arrival, one or more delays, carbon emissions, etc. for the alternative transportation service had the user chosen the alternative transportation service. This can include, for example, the estimated travel duration or time of arrival had the user travelled to the destination using only a ground vehicle service. Such information may have been previously calculated and stored in response to the transportation service request and determination of available transportation services, as previously described.

The computing system 850 can generate a user notification descriptive of a comparison between the alternative transportation service and the multi-modal transportation service and provide the user notification to the user during the multi-modal transportation service. The notification can be provided during a current or subsequent transportation leg, or after the completion of the transportation service.

In the event that the user device is running an application associated with another service platform, the computing system 850 can generate a query to the platform (e.g., based on an API call) requesting that a particular notification or certain information be provided to the user via the platform's software application.

In some implementations, the adjustment action can be based on a predicted overall service score 860. For instance, the computing system 850 can compute the predicted overall service score 860 for the multi-modal transportation service based on one or more quality measurements 855 and user states. By way of example, the computing system 850 can extrapolate the predicted overall service score 860 for the multi-modal transportation service by using the quality measurement 855, one or more previous trip quality measurements for the multi-modal transportation service, and historical contextual data indicative of one or more patterns, trends, etc. for subsequent portions of the multi-modal transportation service. An adjustment action can be initiated to impact the final overall service score 860 before the multi-modal transportation service is completed. For instance, the adjustment action can be performed to increase a trip quality measurement for a subsequent user state to increase an anticipated negative/unfavorable final overall service score 860.

The final overall service score 860 can be disproportionately impacted by negative/unfavorable quality measurements for certain user states. To compensate for the relative impact of a quality measurement, the computing system 850 can determine a weighted quality measurement 855 based on the respective user state.

For example, each of the plurality of predefined user states can be associated with a corresponding weight based on the impact that a quality measurement for the respective user state can have on the overall service score 860. The computing system 850 can determine a weighted quality measurement based on the user state (e.g., the weight corresponding thereto). The predicted overall service score 860 can be computed based on the weighted quality measurement and one or more previously weighted trip quality measurements for the multi-modal transportation service.

The weights corresponding to each of the plurality of user states can be learned or adjusted based on historical transportation data. For example, the computing system 850 can receive feedback data associated with one or more user states of the multi-modal transportation service. The feedback data can include a user rating of at least a portion of the multi-modal transportation service, which can help determine impactful user states. In some implementations, the feedback data can be indicative of whether a user continued to book transportation services after the multi-modal transportation service. The operations computing system 850 can modify a corresponding weight based on the feedback data or real-time quality measurements or a final overall service score 860 for a corresponding multi-modal transportation service.

The weight assigned to a particular user state can be based on the individual user or an aggregate of users. For instance, the computing system 850 can store historical quality measurements 855 associated with user states of past service instances (e.g., in data store 854) as well as the adjustment actions associated therewith. The computing system 850 can analyze the historical data associated with a given user to determine which states (or substates) with negative experiences appear to have the greatest impact on the user's overall experience. Additionally, or alternatively, the computing system 850 can analyze historical data for a plurality of users to determine which states (or substates) with negative experiences appear to have the greatest impact on the group of users' overall experience. By way of example, one or more users may have provided positive ratings of the transportation service for certain journeys that included a longer than expected boarding time, but negative ratings for journeys that included longer times to transition to a ground vehicle for the last transportation leg 106. Thus, the computing system 850 can determine that transition times associated with the intermediate leg transitioning state 885 may be more impactful for a user and, thus, apply a higher weight.

Additionally, or alternatively, the computing system 850 can analyze previous adjustment actions to determine what adjustment action to undertake for a user's current service instance. The data store 854 can store data indicative of the previous adjustment actions taken for a given user and the impact of the adjustment action on an overall service score 860 for that user. By way of example, the historical data may indicate that a user provided a positive rating for a transportation service when the ground vehicle 108 was upgraded to a luxury car, despite longer than expected wait times at various states along the journey. The computing system 850 can determine that this type of adjustment action is preferable to the user.

In some implementations, the computing system 850 can initiate an adjustment action based on the predicted quality measurement. The adjustment action can be a discrete action initiated for the user. For example, a first user (e.g., being negatively impacted by a second user's delay) can be assigned a different seat on the aircraft, provided with notifications, assigned a premium ground vehicle for a subsequent leg, provided with assistance from a facility operator, provided a discount, provided reward points, provided free products/services at an aerial facility, etc. The adjustment action can be initiated to attempt to minimize the impact of the predicted quality measurement (e.g., effected by the second user) on the overall score 860 of the first user.

In some implementations, the computing system 850 can initiate a pre-emptive adjustment action for a user. For example, based on transportation data 895 collected for a plurality of users within the past three hours, the computing system 850 can determine that an aerial facility is experiencing longer than expected wait times for aircraft boarding. The computing system 850 can receive a request for a transportation service for a user. The computing system 850 can access data indicative of historical service data and determine that the user's experience is particularly sensitive to long boarding times.

In response, the computing system 850 can determine a pre-emptive adjustment action for the user based on the historical service data. For example, prior to the user starting the transportation service or the computing system 850 computing a poor quality measurement 855, the computing system 850 can initiate an adjustment action to address the potential extended wait time by providing access to certain areas (e.g., VIP lounges) at a facility, prioritizing user boarding, instructing facility personnel to provide additional services, etc.

In some implementations, a third-party service provider can be selected based on quality measurements 855 associated with that provider. For instance, the computing system 850 can compute and store log data 896 associated with transportation services. The log data 896 can be stored in an accessible memory and used for analyzing third-party service providers.

The log data 896 can include one or more data fields that capture various information. For example, the log data 896 can include fields respectively indicating: a particular itinerary for a multiple-transportation service (e.g., a unique ID for the itinerary), one or more users associated with the service, vehicles (e.g., ground vehicles or aircrafts that transported a user), quality measurements for states or sub-states, overall scores, timestamps, locations (e.g., origin, destinations, aerial facilities), routes, certain events (e.g., traffic, delays), time durations for each state, or other information.

The computing system 850 can process the log data 896 to compute quality measurements 855 associated with a particular third-party service provider. The computing system 850 can iteratively parse the log data 896 to identify certain attributes or combinations of attributes. For example, the computing system 850 can compute what quality measurement 855 is associated with a transit state, the locations associated therewith, and a third-party service provider. This can include for example, identifying a poor quality measurement being associated with a third leg transit state in which a car from ground vehicle service provider A transported a user from aerial facility B to the user's home in city neighborhood C. The computing system 850 can perform a similar analysis over log data 896 for a plurality of transportation services that have been provided by third-party service provider A.

Based on the extracted attributes (or attribute combinations), the computing system 850 can compute an overall quality measurement for third-party service provider A. This can include, for example, the average of all extracted quality measurements associated with the transportation services for that third-party service provider A.

The computing system 850 can utilize the overall quality measurement for service providers to select a service provider for a transportation leg. For example, a third-party service provider with a higher overall quality measurement can be prioritized by the transportation platform that is generating itineraries for requested transportation services. More specifically, the platform can first determine if such third-party service providers are available for a user's requested transportation when generating an itinerary (or making a service available), before evaluating other third-party service providers with lower overall quality measurements.

In some implementations, the computing system 850 can utilize the overall quality measurement for a third-party service provider when performing adjustment actions. For instance, the computing system 850 can determine that an adjustment to a third transportation leg 106 is preferable to counteract lower quality measurements that were computed for early states. To help potentially improve the overall service score 860, the computing system 850 can adjust the third transportation leg such that the user is matched with a ground vehicle from a third-party service provider associated with a higher (or the highest) overall quality measurement.

In some implementations, the selection of the third-party service provider can be based on the combination of attributes identified in the log data 896. For instance, the computing system 850 can calculate that a particular third-party service provider generally has high overall quality measurements. However, based on certain log data 896, the computing system 850 can determine that aircraft or ground vehicles from the particular service provider have lower quality measurements when operating at aerial facility A or within geographic region Y (e.g., a lower “specific” quality measurement). Thus, when generating portions of itineraries or performing adjustment actions associated with this facility or region, the computing system 850 can prioritize other service providers.

In some implementations, the computing system 850 can perform a root cause analysis to determine a cause for a poor quality measurement and take action to avoid such causes in future services. For instance, the computing system 850 can process the log data 896 to identify poor quality measurements associated with states or sub-states that fall below a particular threshold. The computing system 850 can extract the attributes associated with the poor quality by parsing the information in the other data fields associated with the quality measurement.

The computing system 850 can process the attributes to identify attribute combinations or patterns that may be indicative of a cause of a bad experience by a user. The attributes combinations/patterns can be used to compute potential causes for the poor quality measurements and the computing system 850 can perform one or more actions to avoid the potential causes.

In a first example, the computing system 850 can determine that there are typically poor quality measurements when users are transported by car to aerial facility A along a highway route during a certain time range. To help avoid this cause, the computing system can restrict the ability of a car to take the highway route during that certain time range. Additionally, or alternatively, during that time frame, the computing system 850 can restrict transportation by car to only within a certain threshold distance of the aerial facility. In some implementations, the computing system 850 can restrict the type of transportation to bikes, scooter, walking, etc. for a user to take during that time frame. This can also lead to a distance restriction as the service area may be reduced to appropriate distances for biking, scooter-riding, walking, etc. To do so, constraints on matching/routing can be generated in a transportation platform system.

In another example, the computing system 850 can determine that certain aircraft are typically delayed when taking-off from a particular aerial facility and it is resulting in poor quality measurements (e.g., because users are in a boarding state too long). To avoid this potential cause, the computing system 850 can avoid generating itineraries in which those aircraft have to service the particular aerial facility.

In some implementations, the computing system 850 can attempt to avoid causes of poor quality measurements by restricting matching to only service providers with higher associated quality measurements.

The root cause analysis can be extended to include other types of data. For instance, the log data 896 can be appended with information from one or more third-party systems 415. This can include appending weather data or traffic data to log data 896 associated with a particular service instance, state, or sub-state. This can allow the root cause analysis to capture a wider breadth of possible causes for poor user experience.

In some implementations, information from third-party systems 415 can be appended only for certain log data 896. For example, the computing system 850 may access weather data or traffic data from third-party systems 415 for a service instance or state/sub-state, only in the event that the overall service score 860 for that service instance, or the quality measurement 855 for the particular state/substate, falls below a certain threshold (e.g., below a 70 score). This can help preserve the memory resources of the databases storing the log data 896.

The root cause analysis can be based on a plurality of users associated with a common transportation service. For example, four users may be grouped together to ride in an aircraft 107 for an intermediate leg 104 from a first aerial facility to a second aerial facility. Each of the users can arrive at the first aerial facility via different ground vehicles and leave the second aerial facility via different ground vehicles. One of the four users may provide a poor rating of the transportation service.

In performing a root cause analysis, the computing system 850 can compare the differences and similarities between the states of the different users to help understand the root cause for that particular user. This can include, for example, determining that the users had relatively similar state times at each state, but that the user with the negative experience was matched with a different ground transportation platform for the last leg 106. This may help determine how the different ground transportation platform is impacting the user experience for users of the second aerial facility.

In some implementations, the root cause analysis can include comparing overall user experience from one market to another. For example, it may be determined that a first market in which users only walk to a first aerial facility has a lower overall service score aggregated over its population of users than a second, similar market where users are transported via ground vehicles. This can help determine whether the mode of transportation for the first leg in the first market is the root cause of a less favorable user experience.

FIG. 8B depicts a dynamic data model 950 that can be built in real-time as a user progresses along a multi-modal transportation service. The data model 950 can include a data structure that is indicative of the quality measurements for each user state and their relationship to one another. The data structure can be, for example, a timeline graph with a plurality of state specific elements 952A-F that are generated in real-time as data is collected during a user's service instance. The data structure can be stored as an object within data store 854 (of FIG. 8A). The object can be associated with identifiers such as a user identifier or a trip identifier associated with the particular service instance.

Each respective element 952A-D can be associated with a particular user state and store/encode metadata about that state. For example, element 952A is associated with the booking state 865 and includes the start time (to), end time (ti), and the quality measurement for the booking state 865. Element 952B is associated with the first leg transit state 870 and includes the start time (ti), end time (t 2), and the quality measurement for the first leg transit state 870. Element 952C is associated with the first leg transitioning state 875 and includes the start time (t 2), end time (t 3), and the quality measurement for the first leg transitioning state 875. Element 952D is associated with the intermediate leg transit state 880 and includes the start time (t 3), end time (t 4), and the quality measurement for the intermediate leg transit state 880. Element 952E is associated with the intermediate leg transitioning state 885 and includes the start time (t 4), end time (t 5), and the quality measurement for the intermediate leg transitioning state 885. Element 952F is associated with the third leg transit state 890 and includes the start time (t 5), end time (tend), and the quality measurement for the third leg transit state 890.

In some implementations, elements 952A-F can include other metadata associated with a respective state. For instance, an element 952A-F can encode data indicative of pick-up and drop-off locations, traffic conditions, assigned vehicles (e.g., cars, aircraft), operators, aerial facilities, occupancy data (e.g., at facilities, on aircraft), unexpected travel conditions, weather conditions, input features, or any other information associated with a particular state.

The computing system 850 can generate and refine elements 952A-F as the user is transported to the final destination. For example, the computing system 850 can begin to generate the data structure at initiation time (to). The initiation time can coincide with the time at which a user-network session is initiated with the computing system 850 (e.g., a transportation platform) when a software application is launched on a user device. In some implementations, the initiation time can coincide with the time at which a request for transportation services is received by the computing system 850.

The initiation time (to) also represents the start of the booking state 865. For example, a state timer for the booking state 865 can start at to. Based on the analysis described with reference to FIG. 8A, the computing system 850 can generate and refine element 952A as time progresses in the booking state 865. For example, the associated predicted quality measurement for the state can be adjusted (e.g., up or down on the timeline graph) as time progresses. When the booking state 865 ends (e.g., the state timer terminates at ti), the element 952A can reflect the computed quality measurement for the booking state 865 and be stored into the data structure.

The termination of one state can coincide with the initiation of the immediate subsequent state. For example, at ti, the booking state 865 ends and the first leg transit state 870 begins. The computing system 850 can build the data structure for a particular service instance by iteratively generating each element 952A-F as the user experiences and transitions each state in real-time. The computing system 850 can complete the data structure and the generation of elements when the user reaches the final destination (t end).

In some implementations, the elements 952A-F can remain dynamic throughout the entirety of the user's multi-modal transportation service. For example, during a subsequent state, the user (or an operator) may provide feedback that a particular state was less favorable than originally computed. In response, the computing system 850 can adjust the element for that previous state to represent a lower quality measurement than originally computed.

The dynamic data model 950 can provide an improved resource for computing an overall service score. For example, using the data model 950, the computing system 850 can more efficiently reference the quality measurements of each state when computing the overall service score 860, which can be an average or weighted average of the individual quality measurements. Additionally, the data model 950 (or copies thereof) can be stored in the log data 896 to help analyze service provider performance, perform root cause analysis, and other computationally intensive evaluations, as previously described herein.

In some implementations, the overall service score 860 can be initially set at a baseline and adjusted based on each quality measurement 855 as a user's journey progresses. For example, the overall service score 860 can be initially set to 100 points. The number of points can be reduced in response to an unfavorable quality measurement 855. The number of points can be increased in response to a favorable quality measurement 855. In some implementations, the initial score can be the upper score limit. In some implementations, the initial set score can be exceeded.

In some implementations, the overall service score 860 can be relative to a particular user. For example, a particular user can often provide negative feedback, resulting in lower quality measurements 855 for certain states and lower overall service scores 860. The user may continue to utilize the transportation service. Thus, the negative feedback may be indicative of the individual user's approach to rating a service and, thus, can be weighed appropriately for a root cause analysis.

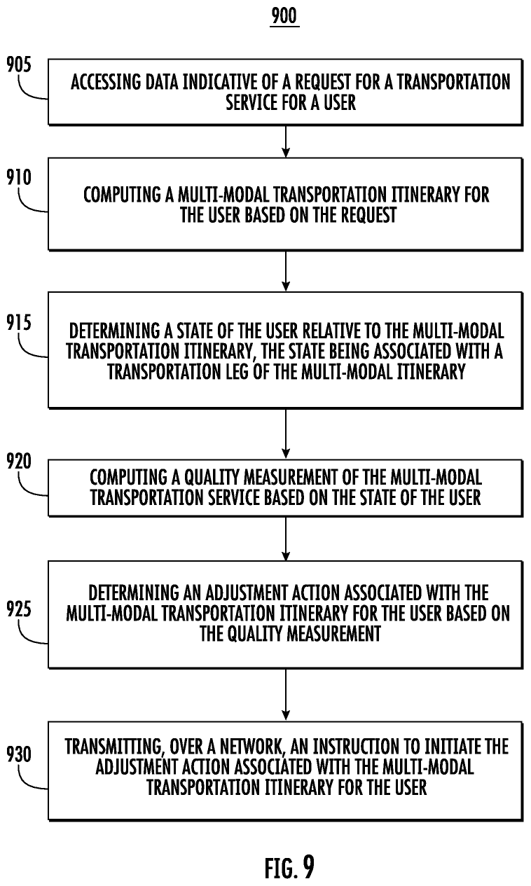

FIG. 9 depicts a flowchart diagram of an example method 900 for initiating an adjustment action according to example embodiments of the present disclosure. The method 900 can be performed by a computing system that includes one or more computing devices such as, for example, the computing systems described with reference to the other figures. Each respective portion of the method 900 can be performed by any (or any combination) of one or more computing devices. Moreover, one or more portion of the method 900 can be implemented as an algorithm on the hardware components of the devices described herein (e.g., as in FIGS. 4-8, 12, etc.), for example, to initiate an adjustment action as discussed herein.

FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for example illustrated purposes and is not meant to be limiting. One or more portions of method 900 can be performed additionally, or alternatively, by other systems.

At 905, a computing system can receive a request for the transportation service. The request can be indicative of a user for the transportation service. The request can at least indicate a desired destination. The desired destination can be, for example, a concert venue. In some implementations, the request can be for a multi-modal transportation service. This can include the user requesting aerial transport for at least a portion of the journey to the concert venue.

At 910, the computing system can compute a multi-modal transportation itinerary for the user based on the request. The multi-modal transportation itinerary can include a plurality of transportation legs for providing the multi-modal transportation service. For example, the itinerary for transporting the user to the concert venue can include the user being transported by car to a first vertiport, the user being transported by aircraft from the first vertiport to a second vertiport, and the user being transported by another car to the concert venue from the second vertiport.

At 915, the computing system can determine the state of the user relative to the multi-modal transportation itinerary. The state can be indicative of a progress of the multi-modal transportation service for the user and/or is associated with a first transportation leg of the multi-modal transportation itinerary. As described herein, the state of the user can include a predefined state such as a transit state indicating the user is being transported or a transition state indicating the user is between transportation legs (e.g., transitioning from one modality to another). These states can include sub-states. The sub-states can indicate, for example, that the user is waiting to board the aircraft to transport the user from the first vertiport to the second vertiport.

The state of the user can be determined based on data from user's mobile device. This can include, for example, GPS-based location data.

At 920, the computing system can compute the quality measurement of the multi-modal transportation service based on the state of the user. As described herein, the quality measurement can predict/estimate the user's satisfaction with the current state of the transportation service. By way of example, the quality measurement can be point-based score associated with a first transit state, while the user is transported to the first vertiport, can continue to decrease the longer the user is stuck in traffic.

At 925, the computing system can determine an adjustment action associated with the multi-modal transportation itinerary for the user based on the quality measurement. As described herein, the adjustment action can include a discrete action that adjusts the user's itinerary or an element thereof. The adjustment action can include an adjustment associated with a second transportation leg of the multi-modal transportation itinerary. In this example, the second transportation leg is subsequent to the first transportation leg.

For instance, the quality measurement associated with the user's transit state can be low due to an excessive wait time while the user is caught in traffic. The quality measurement can be low enough to negatively impact the overall service score for the user. In response, the computing system can determine that an adjustment action may be appropriate to try to improve the user's overall service score. As described herein, the computing system can analyze previous service instances of the user and determine that an adjustment to the final transport leg can be particularly impactful for this user. Thus, the computing system can determine that an adjustment action to prioritize matching the user with a car and upgrading the user to a luxury car may be appropriate.

At 930, the computing system can transmit, over a network, an instruction to initiate the adjustment action associated with the multi-modal transportation itinerary for the user. The instructions can include data, computing instructions, etc. that can be implemented by a computing device. For example, the computing system can call an API to structure a query to send to a ground transportation platform to request a luxury car for the user, with an increased level of prioritization such that the user has little to no wait time for the car.

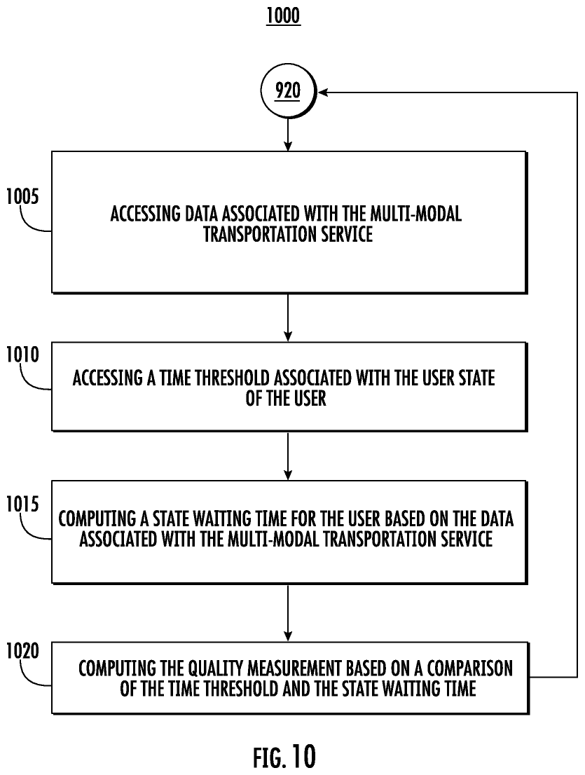

FIG. 10 depicts a flowchart diagram of an example method 1000 for computing a quality measurement according to example embodiments of the present disclosure. The method 1000 can be performed by a computing system that includes one or more computing devices such as, for example, the computing systems described with reference to the other figures. Each respective portion of the method 1000 can be performed by any (or any combination) of one or more computing devices. Moreover, one or more portion of the method 1000 can be implemented as an algorithm on the hardware components of the devices described herein (e.g., as in FIGS. 4-8, 12, etc.), for example, to compute a quality measurement.

FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for example illustrated purposes and is not meant to be limiting. One or more portions of method 1000 can be performed additionally, or alternatively, by other systems.

The method 1000 can include suboperations of operation 920 of FIG. 9 where the method 900 includes computing a quality measurement of the multi-modal transportation service based on the state of the user.

At 1005, a computing system can access data associated with the multi-modal transportation service. As described herein, the data associated with the multi-modal transportation services can include at least one of timing data, movement data, data associated with another user, or other data received from at least one of a plurality of distributed computing devices associated with the multi-modal transportation service. The timing data can indicate, for example, when a user was picked-up, when the user arrived at a first vertiport, checked-in for a flight leg, etc.

At 1010, the computing system can access a time threshold associated with a user state of the user. The time threshold can be based on historical transportation data for the user state, as described herein. The historical transportation data can indicate historic transit times for similar transportation services (and states thereof) to a particular vertiport. For instance, the historical transportation data can indicate that for this particular service instance, a user can expect it to take 5 minutes to arrive at the first vertiport.

At 1015, the computing system can compute a state waiting time for the user based on the data associated with the multi-modal transportation service. The state waiting time can be descriptive of a period of time that the user remains in the user state. As described herein, the state waiting time can be initiated by a state timer. For example, the state waiting time for a transit state can be initiated after the user is picked-up. In this example, the state waiting time can indicate that the user has been travelling in the transit state for 10 minutes to arrive at the first vertiport.

At 1020, the computing system can compute the real-time quality measurement based on the comparison of the time threshold and the state waiting time. The quality measurement can be computed in real-time in that it can be computed while the user is in that state for the transportation service. For example, while the user is being transported to the first vertiport, the quality measurement for the user's transit state can be low because the state waiting time (e.g., 10 minutes) exceeds the time threshold (e.g., 5 minutes). The real-time quality measurement can continue to decrease as the state waiting time increases until the user arrives at the first vertiport.

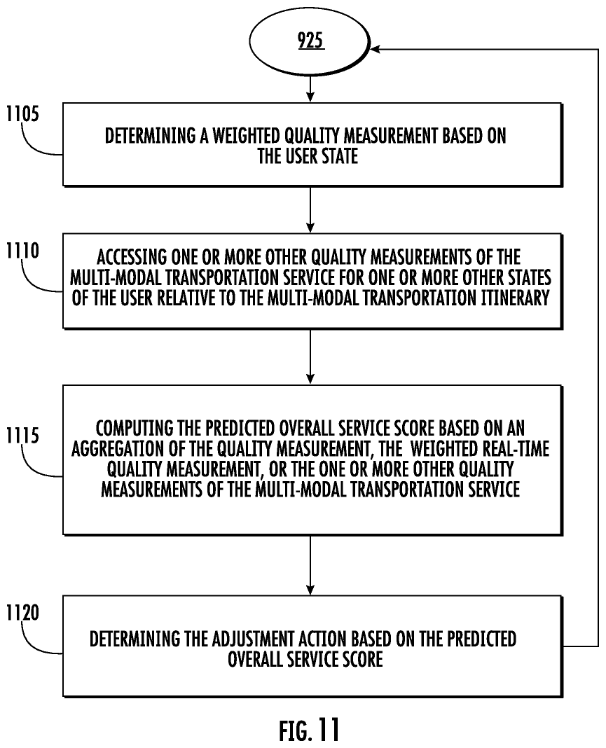

FIG. 11 depicts a flowchart diagram of an example method 1100 for computing a predicted overall service score according to example embodiments of the present disclosure. The method 1100 can be performed by a computing system that includes one or more computing devices such as, for example, the computing systems described with reference to the other figures. Each respective portion of the method 1100 can be performed by any (or any combination) of one or more computing devices. Moreover, one or more portion of the method 1100 can be implemented as an algorithm on the hardware components of the devices described herein (e.g., as in FIGS. 4-8, 12, etc.), for example, to compute a predicted overall service score.

FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of method 1100 can be performed additionally, or alternatively, by other systems.

The method 1100 can include suboperations of operation 925 of FIG. 9 where the method 900 includes determining an adjustment action associated with the multi-modal transportation itinerary for the user based on the quality measurement.

At 1105, a computing system can determine the weighted quality measurement based on the weight of the predefined particular user state, as described herein. This can be a predetermined weight associated to that particular state. As described herein, the weight for a particular user state can be different than that of another user state.

For example, historical data associated with a user can inform the computing system that the user is particularly sensitive to long transit times while being transported to a first vertiport. Thus, the quality measurement for the user's transit state can be afforded a higher weight than the quality measurements for one or more other states.

At 1110, the computing system can access one or more other quality measurements of the multi-modal transportation service for one or more other states of the user relative to the multi-modal transportation itinerary. For example, the computing system can access a memory storing a data structure that has logged the respective quality measurements of the various states of the user during the multi-modal transportation service. This can include the quality measurements associated with a state in which the user waits to board the aircraft, a transit state where the user is transported by aircraft, etc. One or more of these other states may be afforded a weight that is lower than the one assigned to the transit state in which the user is transported by car to the first vertiport.

At 1115, the method 1100 includes computing the predicted overall service score based on an aggregation of the quality measurements. For example, the computing system can compute the predicted overall service score based on the aggregation of the quality measurement, the weighted quality measurement, and/or the one or more other quality measurements of the multi-modal transportation service. The predicted overall service score can be indicative of a predicted quality of the multi-modal transportation service across a plurality of states. This can include an aggregation of the quality measurements for states experienced (or being experienced) by the user.

In some implementations, future states not yet experienced by the user can be afforded a default quality measurement. The default quality measurement can be an initial level (e.g., 100/100) that assumes the state will be favorable. In some implementations, default quality measurement for a future state can be predicted based on the experiences of other users. For example, the default quality measurement for a future state in which the user waits for a final car to reach the concert venue can be lowered in the event that users currently at the second vertiport are experiencing pick-up delays due to traffic.

At 1120, the computing system can determine the adjustment action based on the predicted overall service score. The adjustment action is configured to impact a final overall service score, as described herein, to help improve the overall service score. For example, in the event that the overall service score is negatively impacted by a low quality measurement for a first leg transit state, the computing system can assign the user to a better seat on an aircraft, prioritize future vehicle matching, etc.

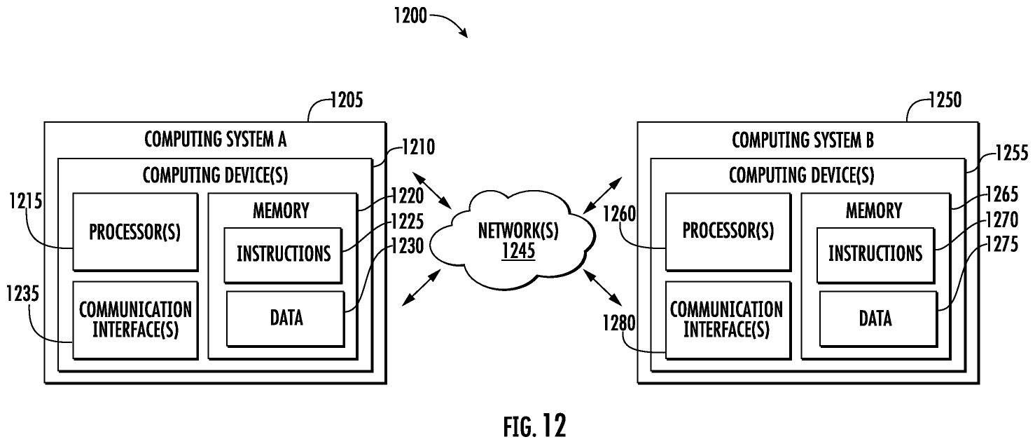

FIG. 12 depicts example system components of an example system 1200 according to example implementations of the present disclosure. The example system 1200 can include the computing system 1205 and the computing system 1250 that are communicatively coupled over one or more networks 1245. The computing systems 1205/1205 (and its associated devices) can represent, for example, any of the computing systems/devices described herein.

The computing system 1205 can include one or more computing devices 1210. The computing devices 1210 of the computing system 1205 can include one or more processors 1215 and a memory 1220. The processors 1215 can be any suitable processing device (e.g., a processor core, a microprocessor, an ASIC, a FPGA, a controller, a microcontroller, etc.) and can be one processor or a plurality of processors that are operatively connected. The memory 1220 can include one or more non-transitory computer-readable storage media, such as RAM, ROM, EEPROM, EPROM, one or more memory devices, flash memory devices, etc., and combinations thereof.

The memory 1220 can store information that can be accessed by the processors 1215. For instance, the memory 1220 (e.g., one or more non-transitory computer-readable storage mediums, memory devices) can include computer-readable instructions 1225 that can be executed by the processors 1215. The instructions 1225 can be software written in any suitable programming language or can be implemented in hardware. Additionally, or alternatively, the instructions 1225 can be executed in logically or virtually separate threads on processors 1215.

For example, the memory 1220 can store instructions 1225 that when executed by the processors 1215 cause the processors 1215 to perform operations such as any of the operations and functions of any of the computing systems (e.g., ATP system, GTP system, third-party provider system, airspace system, etc.) or computing devices (e.g., user devices, ground vehicle devices, aircraft devices, aerial facility devices facility operator user devices, etc.), as described herein.

The memory 1220 can store data 1230 that can be obtained, received, accessed, written, manipulated, created, or stored. The data 1230 can include, for instance, quality measurements, overall scores, or any other information or other data/information described herein. In some implementations, the computing devices 1210 can access from or store data in one or more memory devices that are remote from the computing system 1205 such as one or more memory devices of the computing system 1250.

The computing devices 1210 can also include a communication interface 1235 used to communicate with one or more other systems (e.g., computing system 1250). The communication interface 1235 can include any circuits, components, software, etc. for communicating via one or more networks (e.g., 1245). In some implementations, the communication interface 1235 can include for example, one or more of a communications controller, receiver, transceiver, transmitter, port, conductors, software, or hardware for communicating data/information.

The computing system 1250 can include one or more computing devices 1255. The computing devices 1255 can include one or more processors 1260 and a memory 1265. The one or more processors 1260 can be any suitable processing device (e.g., a processor core, a microprocessor, an ASIC, a FPGA, a controller, a microcontroller, etc.) and can be one processor or a plurality of processors that are operatively connected. The memory 1265 can include one or more non-transitory computer-readable storage media, such as RAM, ROM, EEPROM, EPROM, one or more memory devices, flash memory devices, etc., and combinations thereof.

The memory 1265 can store information that can be accessed by the processors 1260. For instance, the memory 1265 (e.g., one or more non-transitory computer-readable storage mediums, memory devices) can store data 1275 that can be accessed (e.g., obtained, received, accessed, written, manipulated, created, stored, etc.). The data 1275 can include, for instance, any of the data or information described herein. In some implementations, the computing system 1250 can access data memory from one or more devices that are remote from the computing system 1250.

The memory 1265 can also store computer-readable instructions 1270 that can be executed by the processors 1260. The instructions 1270 can be software written in any suitable programming language or can be implemented in hardware. Additionally, or alternatively, the instructions 1270 can be executed in logically or virtually separate threads on processors 1260. For example, the memory 1265 can store instructions 1270 that when executed by the processors 1260 cause the processors 1260 to perform any of the operations or functions described herein, including, for example, any of the operations and functions of any of the computing systems (e.g., ATP system, GTP system, third-party provider system, airspace system, etc.) or computing devices (e.g., user devices, ground vehicle devices, aircraft devices, aerial facility devices facility operator user devices, etc.), as described herein.

The computing devices 1255 can also include a communication interface 1280 used to communicate with one or more other systems. The communication interface 1280 can include any circuits, components, software, etc. for communicating via one or more networks (e.g., 1245). In some implementations, the communication interface 1280 can include for example, one or more of a communications controller, receiver, transceiver, transmitter, port, conductors, software, or hardware for communicating data/information.

The networks 1245 can be any type of network or combination of networks that allows for communication between devices. In some implementations, the networks 1245 can include one or more of a local area network, wide area network, the Internet, secure network, cellular network, mesh network, peer-to-peer communication link or some combination thereof and can include any number of wired or wireless links. Communication over the networks 1245 can be accomplished, for instance, via a network interface using any type of protocol, protection scheme, encoding, format, packaging, etc.

FIG. 12 illustrates one example system 1200 that can be used to implement the present disclosure. Other computing systems can be used as well. Computing tasks discussed herein as being performed at computing devices remote from a one system (e.g., of a vehicle) can instead be performed at another system (e.g., via the vehicle computing system), or vice versa. Such configurations can be implemented without deviating from the scope of the present disclosure.

The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc. It should also be understood that any of claims provided herein can be combined or depend from one another.

What is claimed is:

1. A computer-implemented method comprising:
accessing data indicative of a request for a transportation service, wherein the request is indicative of a user for the transportation service;
computing a multi-modal transportation itinerary for the user based on the request, wherein the multi-modal transportation itinerary comprises a plurality of transportation legs for providing the multi-modal transportation service;
determining a state of the user relative to the multi-modal transportation itinerary, wherein the state is indicative of a progress of the multi-modal transportation service for the user, and wherein the state is associated with a transportation leg of the multi-modal transportation itinerary;
computing a quality measurement of the multi-modal transportation service based on the state of the user;
determining an adjustment action associated with the multi-modal transportation itinerary for the user based on the quality measurement, wherein the adjustment action comprises an adjustment associated with another transportation leg of the multi-modal transportation itinerary, the other transportation leg being subsequent to the transportation leg; and
transmitting, over a network, an instruction to initiate the adjustment action associated with the multi-modal transportation itinerary for the user.

2. The computer-implemented method of claim 1, wherein the other transportation leg comprises a ground transportation service for the user, and wherein the adjustment action comprises at least one of: (i) initiating an adjustment to the ground transportation for the user; or (ii) initiating an increase in a priority associated with the user for the ground transportation.

3. The computer-implemented method of claim 2, wherein adjusting the ground transportation for the user comprises at least one of: (i) assigning a different ground vehicle to the user; (ii) changing a service level associated with the ground transportation for the user; or (iii) changing a service type associated with the ground transportation.

4. The computer-implemented method of claim 2, wherein increasing the priority associated with the user for the ground transportation comprises adjusting a data structure for assigning a ground vehicle to the user to increase the priority with which the ground vehicle is assigned to the user.

5. The computer-implemented method of claim 1, wherein the other transportation leg comprises an aerial transportation service for the user, and wherein the adjustment action comprises at least one of: (i) initiating an adjustment of a seat for the user on an aircraft to be used for the aerial transportation service; or (ii) initiating an assignment of the user to a different aircraft for the aerial transportation service.

6. The computer-implemented method of claim 1, wherein computing the quality measurement of the multi-modal transportation service based on the state of the user comprises:
accessing data associated with the multi-modal transportation service, wherein the data associated with the multi-modal transportation services comprises at least one of timing data, movement data, data associated with another user, or event data received from at least one of a plurality of distributed computing devices associated with the multi-modal transportation service; and
computing the quality measurement of the multi-modal transportation service based on the state of the user and the data associated with the multi-modal transportation service.

7. The computer-implemented method of claim 6, wherein computing the quality measurement of the multi-modal transportation service based on the state of the user and the data associated with the multi-modal transportation service comprises:
accessing a time threshold associated with the user state of the user, wherein the time threshold is based on historical transportation data for the user state;
computing a state waiting time for the user based on the data associated with the multi-modal transportation service, the state waiting time descriptive of a period of time that the user remains in the user state; and
computing the quality measurement based on a comparison of the time threshold and the state waiting time.

8. The computer-implemented method of claim 7, wherein the user is associated with one or more user characteristics, and wherein the time threshold associated with the user state is based the one or more user characteristics.

9. The computer-implemented method of claim 7, wherein the time threshold associated with the user state is based on a geographic region associated with the multi-modal transportation service.

10. The computer-implemented method of claim 1, wherein determining the adjustment action associated with the multi-modal transportation itinerary for the user based on the quality measurement comprises:
computing a predicted overall service score for the multi-modal transportation service based on the quality measurement, wherein the predicted overall service score is indicative of a predicted quality of the multi-modal transportation service across a plurality of states of the multi-modal transportation service; and
determining the adjustment action based on the predicted overall service score, wherein the adjustment action is configured to impact a final overall service score.

11. The computer-implemented method of claim 10, wherein computing the predicted overall service score for the multi-modal transportation service comprises:
determining a weighted quality measurement based on the user state; and
computing the predicted overall service score based on the weighted quality measurement.

12. The computer-implemented method of claim 10, wherein computing the predicted overall service score for the multi-modal transportation service comprises:
accessing one or more other quality measurements of the multi-modal transportation service for one or more other states of the user relative to the multi-modal transportation itinerary; and
computing the predicted overall service score based on an aggregation of the quality measurement and the one or more other quality measurements of the multi-modal transportation service.

13. The computer-implemented method of claim 1, wherein the state is one of a plurality of predefined user states, the plurality of predefined user states comprising a transit state, a transitional state, a boarding state, a ready state, and an arrival state.

14. One or more non-transitory, computer-readable media storing instructions that are executable by one or more processors to cause the one or more processors to perform operations, the operations comprising:
accessing data indicative of a multi-modal transportation itinerary for a user, wherein the multi-modal transportation itinerary comprises a plurality of transportation legs for providing a transportation service for the user;
determining a state of the user relative to the multi-modal transportation itinerary, wherein the state is indicative of a progress of the multi-modal transportation service for the user, and wherein the state is associated with a transportation leg of the multi-modal transportation itinerary;
computing a quality measurement of the multi-modal transportation service based on the state of the user;
determining an adjustment action associated with the multi-modal transportation itinerary for the user based on the quality measurement, wherein the adjustment action comprises an adjustment associated with another transportation leg of the multi-modal transportation itinerary, the other transportation leg being subsequent to the transportation leg; and
transmitting, over a network, an instruction to initiate the adjustment action associated with the multi-modal transportation itinerary for the user.

15. The one or more non-transitory, computer-readable media of claim 14, wherein the user is associated with a user device configured to run a software application associated with the transportation service, and wherein the adjustment action comprises a modification to at least one user interface of the software application.

16. The one or more non-transitory, computer-readable media of claim 15, wherein the at least one user interface of the software application is configured to provide one or more user notifications, and wherein initiating the adjustment action comprises:
accessing alternative transportation data associated with an alternative transportation service;
computing a user notification descriptive of a comparison between the alternative transportation service and the multi-modal transportation service; and
transmitting, over the network, data indicative of the user notification to the user device during the multi-modal transportation service.

17. The one or more non-transitory, computer-readable media of claim 1, wherein the adjustment action comprises notifying an operator at an aerial facility to assist the user in transitioning between a ground transportation service to an aerial transportation service, and wherein transmitting the instruction to initiate the adjustment action comprises transmitting, to a user device associated with the operator, data indicative of a notification to assist the user while at the aerial facility.

18. The one or more non-transitory, computer-readable media of claim 14, wherein the user state is one of a plurality of predefined user states, wherein each respective state is associated with a corresponding weight for determining a weight quality measurement associated with the respective state.

19. The one or more non-transitory, computer-readable media of claim 18, wherein the operations further comprise:
receiving feedback data associated with the transportation service; and
modifying the corresponding weight of at least one respective state based on the feedback data.

20. A computing system comprising:
one or more processors; and
one or more tangible, non-transitory, computer readable media that store instructions that are executable by the one or more processors to cause the computing system to perform operations, the operations comprising:
accessing data indicative of a request for a transportation service, wherein the request is indicative of a user of the transportation service;
computing a multi-modal transportation itinerary for the user based on the request, wherein the multi-modal transportation itinerary comprises at least two transportation legs for providing the multi-modal transportation service;
accessing data associated with the multi-modal transportation service and data associated with a state of the user relative to the multi-modal transportation itinerary, wherein the data associated with the multi-modal transportation service is indicative of a location of the user relative to the multi-modal transportation itinerary;
computing a quality measurement of the multi-modal transportation service based on the data associated with the multi-modal transportation service and the data associated with the state of the user; and
initiating an adjustment action associated with the multi-modal transportation itinerary for the user based on the quality measurement.
